(19) United States
(12) Patent Application Publication
(10) Pub. No.: US 2019/0081370 A1
(43) Pub. Date: Mar. 14, 2019

(54) EMBEDDED CURRENT COLLECTOR FOR ELECTRIC VEHICLE BATTERY MONITORING

(71) Applicant: SF Motors, Inc., Santa Clara, CA (US)

(72) Inventors: Nathalie Capati, Santa Clara, CA (US); Duanyang Wang, Santa Clara, CA (US); Jacob Heth, Santa Clara, CA (US); Binbin Chi, Santa Clara, CA (US)

(21) Appl. No.: 16/118,366

(22) Filed: Aug. 30, 2018

Related U.S. Application Data
(60) Provisional application No. 62/557,676, filed on Sep. 12, 2017.

(51) Int. Cl. H01M 10/48; H01M 2/10; H01M 10/42

(52) U.S. Cl. CPC H01M 10/482; H01M 2/1077; H01M 2220/20; H01M 2010/4278; H01M 10/4257

(57) ABSTRACT

Systems, methods, devices, and apparatuses associate with energy storage are provided. An apparatus can include a battery block with battery cells disposed therein. The apparatus can include an integrated current collector to electrically couple the battery cells in parallel. The integrated current collector can have a first conductive layer to connect with first polarity terminals of the battery cells, a second conductive layer to connect with second polarity terminals of the battery cells, and a circuit board layer parallel to the two conductive layers. The apparatus can include trace lines each formed on the circuit board layer and connected to the two conductive layers. The apparatus can include a battery monitoring unit (BMU) incorporated on the circuit board layer. The BMU can have inputs coupled with the two conductive layers to obtain a signal indicative of a characteristic of the battery block.

### CROSS-REFERENCES TO RELATED APPLICATIONS

This application claims priority under 35 U.S.C. § 119(e) to U.S. Provisional Application No. 62/557,676, titled “EMBEDDED BUSBAR FOR BATTERY MONITORING,” filed Sep. 12, 2017, which is incorporated by reference in its entirety.

### BACKGROUND

There is an increasing demand for reliable and higher capacity battery cells for high power, higher performance battery packs, to support applications in plug-in hybrid electrical vehicles (PHEVs), hybrid electrical vehicles (HEVs), or electrical vehicle (EV) systems, for example. Physical, electrical, or other operational characteristics of battery pack modules can indicate whether or not performance of the battery pack module is satisfactory, and can also indicate a need for maintenance or operational adjustments. However, monitoring the performance of these battery packs can be difficult, which can decrease reliability and can hinder maintenance and serviceability in the field.

### SUMMARY

The present disclosure is directed to battery packs that can include battery monitoring units (BMUs) to measure characteristics of the battery pack modules via an integrated current collector of the battery pack with embedded trace lines. The embedded trace lines of the integrated current collector can be used to avoid dedicated BMU physical wires or sense lines connecting the BMU with battery pack components.

At least one aspect is directed to an apparatus to store electrical energy in electrical vehicles to power components therein. The apparatus can include a battery block disposed in a battery pack of an electric vehicle to power the electric vehicle. The apparatus can include a plurality of battery cells disposed within the battery block to store electrical energy. The apparatus can include an integrated current collector disposed within the battery block to electrically couple the plurality of battery cells in parallel. The integrated current collector can have a first conductive layer to connect with first polarity terminals of the plurality of battery cells, a second conductive layer to connect with second polarity terminals of the plurality of battery cells, and a circuit board layer parallel to the first conductive layer and the second conductive layer. The apparatus can include a plurality of electrically conductive trace lines each at least partially embedded in the integrated current collector and formed on the circuit board layer. The plurality of electrically conductive trace lines can have a first electrically conductive trace line electrically connected to the first conductive layer and a second electrically conductive trace line electrically connected to the second conductive layer. The first electrically conductive trace line can be electrically isolated from the second electrically conductive trace line. The apparatus can include a battery monitoring unit (BMU) incorporated into the integrated current collector on the circuit board layer. The BMU can have a first input electrically coupled with the first conductive layer via the first electrically conductive trace line on the circuit board layer and a second input electrically coupled with the second conductive layer via the second electrically conductive trace line on the circuit board layer. The BMU can obtain a signal indicative of a characteristic of the battery block.

At least one aspect is directed to a method. The method can include providing a battery pack to arrange in an electric vehicle to power the electric vehicle. The battery pack can have a battery block. The battery pack can have a plurality of battery cells disposed within the battery block to store electrical energy. The battery pack can have an integrated current collector disposed within the battery block to electrically couple the plurality of battery cells in parallel. The integrated current collector can have a first conductive layer to connect with first polarity terminals of the plurality of battery cells, a second conductive layer to connect with second polarity terminals of the plurality of battery cells, and a circuit board layer parallel to the first conductive layer and the second conductive layer. The battery pack can have a plurality of electrically conductive trace lines each at least partially embedded in the integrated current collector and formed on the circuit board layer. The plurality of electrically conductive trace lines can have a first electrically conductive trace line electrically connected to the first conductive layer and a second electrically conductive trace line electrically connected to the second conductive layer. The first electrically conductive trace line can be electrically isolated from the second electrically conductive trace line. The battery pack can have a battery monitoring unit (BMU) incorporated into the integrated current collector on the circuit board layer. The BMU can have a first input electrically coupled with the first conductive layer via the first electrically conductive trace line on the circuit board layer and a second input electrically coupled with the second conductive layer via the second electrically conductive trace line on the circuit board layer. The BMU can obtain a signal indicative of a characteristic of the battery block.

At least one aspect is directed to an electric vehicle. The electric vehicle can include one or more components. The electric vehicle can include a battery block disposed in a battery pack of to power the one or more components. The electric vehicle can include a plurality of battery cells disposed within the battery block to store electrical energy. The electric vehicle can include an integrated current collector disposed within the battery block to electrically couple the plurality of battery cells in parallel. The integrated current collector can have a first conductive layer to connect with first polarity terminals of the plurality of battery cells, a second conductive layer to connect with second polarity terminals of the plurality of battery cells, and a circuit board layer parallel to the first conductive layer and the second conductive layer. The electric vehicle can include a plurality of electrically conductive trace lines each at least partially embedded in the integrated current collector and formed on the circuit board layer. The plurality of electrically conductive trace lines can have a first electrically conductive trace line electrically connected to the first conductive layer and a second electrically conductive trace line electrically connected to the second conductive layer. The first electrically conductive trace line can be electrically isolated from the second electrically conductive trace line. The electric vehicle can include a battery monitoring unit (BMU) incorporated into the integrated current collector on the circuit board layer. The BMU can have a first input electrically coupled with the first conductive layer via the first electrically conductive trace line on the circuit board layer and a second input electrically coupled with the second conductive layer via the second electrically conductive trace line on the circuit board layer. The BMU can obtain a signal indicative of a characteristic of the battery block.

### BRIEF DESCRIPTION OF THE DRAWINGS

The accompanying drawings are not necessarily intended to be drawn to scale. Like reference numbers and designations in the various drawings indicate like elements. For purposes of clarity, not every component may be labelled in every drawing. In the drawings:

FIG. 1 depicts an overhead view of an illustrative embodiment of a system for providing energy storage with component monitoring capability;

FIG. 2 depicts an isometric view of an illustrative embodiment of a system for providing energy storage with component monitoring capability;

FIG. 3 depicts an isometric and close-up view to a portion of an illustrative embodiment of a system for providing energy storage with component monitoring capability;

FIG. 4 depicts a block diagram depicting a cross-sectional view of an illustrative embodiment of an electric vehicle installed with a battery pack;

FIG. 5 depicts a flow diagram of an illustrative embodiment of a method for providing energy storage with component monitoring capability;

FIG. 6 depicts a flow diagram of an illustrative embodiment of a method for providing energy storage with component monitoring capability; and

FIG. 7 depicts a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, devices, and systems of a battery management system to monitor battery pack and components therein. The various concepts introduced above and discussed in greater detail below may be implemented in any of numerous ways.

Described herein are methods, devices, and apparatuses for battery management system to monitor battery pack and components therein for an automotive configuration. An automotive configuration includes a configuration, arrangement or network of electrical, electronic, mechanical or electromechanical devices within a vehicle of any type. An automotive configuration can include battery cells for battery packs in electric vehicles (EVs). EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. EVs can include various components that run on electrical power. These various components can include an electric engine, an entertainment system (e.g., a radio, display screen, and sound system), on-board diagnostics system, and electric control units (ECUs) (e.g., an engine control module, a transmission control module, a brake control module, and a body control module), among other components.

Battery packs can be connected with a battery management system (BMS). The BMS can dynamically control various operations of the battery pack to attain or meet a performance criteria or operational condition. The BMS can also detect and log faults or error condition occurring in the battery pack (e.g., a thermal runaway condition), and can interface with components outside the battery pack to communicate diagnostic information regarding the operations of the battery pack. In controlling the various operations of the battery pack, the BMS can acquire characteristics of the various components in the battery pack from one or more battery monitoring units (BMUs). The characteristics measured by the BMU can include, for example, temperature from the heat released from submodules and voltage and current outputted from the battery cells, among others. For example, when the voltage and current outputted from the battery cells is outside the specifications of the performance criteria, the BMS can increase or decrease the voltage and current drawn from the battery cells. In addition, when the temperature of the submodules is greater than a tolerance level designated by the performance criteria or operational condition, the BMS can for instance increase an amount of coolant provided to the affected submodules to regulate heat. Achieving the performance criteria can entail the BMU making accurate and precise measurements of the characteristics of the components in the battery pack.

One approach to obtaining measurements of these characteristics can include directly connecting sense lines onto a source of the measurements, such as the components of the battery pack. The sense line can be comprised of an electrically conductive material to measure voltage or current or to measure temperature. The sense line can be extended from the BMU, and can be attached to the components to be measured by soldering one end of the sense line along an outer surface of the component. Attaching sense lines in this manner, however, can be problematic for a number of reasons. For one, it may be difficult to directly attach sense lines onto the outer surface of the components to be measured for accurate and precise measurements. For example, there may be a limited amount of space for sprouting or connecting sense lines, depending on the number of sense lines to be attached per submodule and an amount of space available on the outer surface of the components to be measured. This difficulty may be exacerbated in densely packed battery packs with constrained spacing between battery cells and size of the submodules holding the battery cells. Non-direct attachment of sense lines to the components may result in inaccurate, imprecise, and unreliable measurements of the characteristics of the components. For another, manually soldering sense lines onto the outer surface of the component may yield inconsistent bond quality. Inconsistent bonding can result in unreliable and inaccurate measurements of the characteristics of the battery pack. Moreover, poor bonding can lead to subsequent detachment of the sense lines, leading to difficulty in acquiring measurements through the affected sense lines. Not to mention, manual soldering of sense lines may substantially increase the assembly time of the battery packs in connecting with the BMU relative to assembly without soldering.

To address the technical problems arising from soldering sense lines from the BMS or BMU with the various components of the battery pack, the BMU can be directly incorporated into the battery pack itself. The battery pack can include one or more submodules (sometimes referred herein as a battery block). Each submodule can house battery cells to store electrical energy. Each submodule can also have an integrated current collector. The integrated current collector can have a stack of layers to electrically couple the battery cells in submodule with a positive terminal layer and a negative terminal layer to provide electrical energy to the components of the electric vehicle. Above these two layers, the integrated current collector can have a circuit board layer formed on top. The circuit board layer can have the BMU and a number of electrical impedance components (e.g., resistors and capacitors) to control operations of the submodule arranged along the top surface of the layer. A set of conductive trace lines embedded on the circuit board layer to electrically couple the BMU and the electrical impedance components to one another. The BMU and the electrical impedance components can be coupled with the positive terminal layer and the negative terminal layer of the integrated current collector below through the circuit board layer via wire bonding or contact. By directly embedding onto the one of the layers of the integrated current collector, the BMU can be in proximity with the components of the battery pack to be measured, thereby yielding more accurate, precise, and reliable measurements of the characteristics (e.g., voltage, current, and temperature), as compared with a BMU located away from various components of the battery pack. In addition, forming the circuit board layer for instance directly on top of the positive terminal and negative terminal layers can reduce the likelihood that the BMU becomes disconnected from the measured components as may be with soldering sense lines. Furthermore, the addition of the circuit board layer in this manner can effectively combine the BMU with the current collector into a single integrated component, thereby eliminating the use of a BMU board separate from the current collector layers.

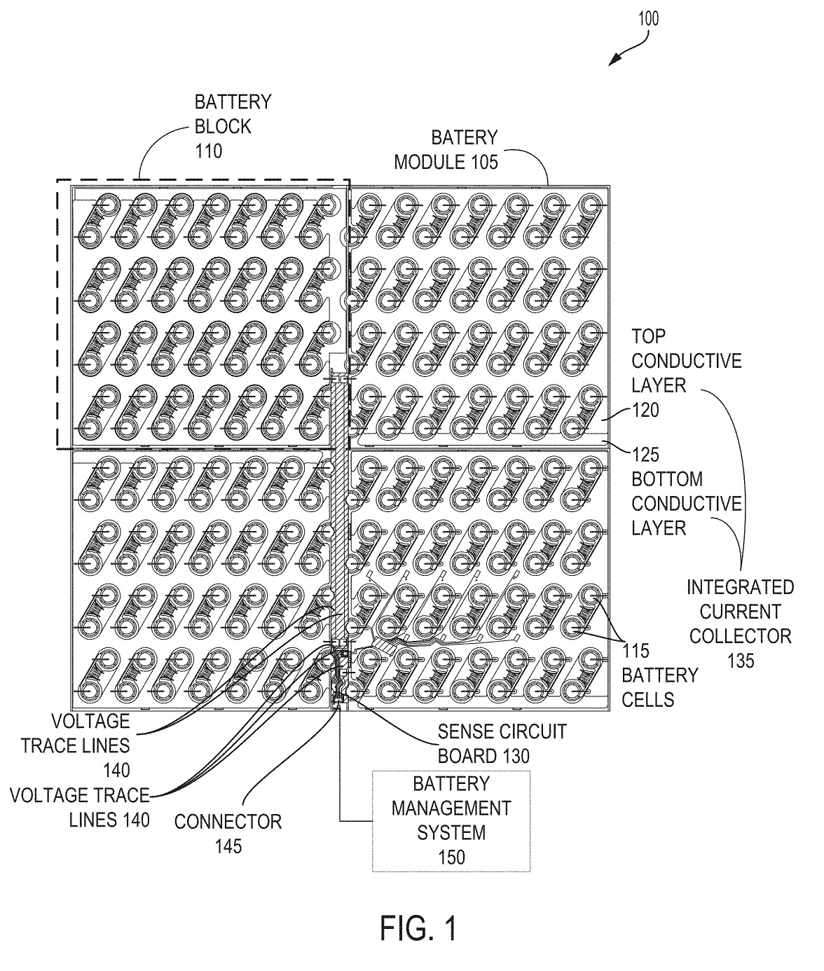

FIG. 1, among others, depicts an overhead view of an illustrative embodiment of a system or an apparatus 100 for providing energy storage with component monitoring capability. The apparatus 100 can be installed or included in an electric vehicle. The apparatus 100 can include a set of battery cells 115 to store and to provide electrical energy. The battery cells 115 can include a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The battery cell 115 can have or define a positive terminal and a negative terminal. Both the positive terminal and the negative terminal can be accessed or defined along one surface of the battery cell 115 (e.g., as depicted). For example, the positive terminal can be defined on a central portion of the top surface of the battery cell 115, and the negative terminal can be defined on a side wall extending up and around the central portion of the top surface of the battery cell 115. The surface of the battery cell 115 defining the positive and the negative terminal can be exposed (e.g., to air). A shape of the battery cell 115 can be a prismatic casing with a polygonal base, such as a triangle, square, a rectangular, a pentagon, or a hexagon. The shape of the battery cell 115 can also be cylindrical casing or cylindrical cell with a circular (e.g., as depicted), ovular, or elliptical base, among others. A height of each battery cell 115 can be 60 mm to 100 mm. A width or diameter of each battery cell 115 can be 16 mm to 30 mm. A length of each battery cell 115 can be 16 mm to 30 mm. Each battery cell 115 can have an output of 2V to 4V.

The apparatus 100 can include at least one battery block 110. A set of battery cells 115 can form a battery block 110. The battery block 110 can support or include at least one battery cell 115. Each battery block 110 can define or include one or more holders. Each holder can be a volume of space extending partially from one side of the battery block 110. Each holder can contain, support, or house at least one of the battery cells 115. The battery block 110 can be comprised of electrically insulating, and thermally conductive material around the holder for the battery cells 115. Examples of thermally conductive material for the battery block 110 can include a ceramic material (e.g., silicon nitride, silicon carbide, titanium carbide, zirconium dioxide, and beryllium oxide) and a thermoplastic material (e.g., acrylic glass, polyethylene, polypropylene, polystyrene, or polyvinyl chloride), among others. A shape of the battery block 110 can be a prismatic casing with a polygonal base, such as a triangle, a square, a rectangular (e.g., as depicted), a pentagon, or a hexagon, among others. The shape of the battery block 110 can also be cylindrical casing or cylindrical cell with a circular, ovular, or elliptical base, among others. The shapes of the battery blocks 110 can vary from one another. A height of each battery block 110 can be 65 m to 100 mm. A width or diameter of each battery block 110 can be 150 mm to 170 mm. A length of each battery block 110 can be 150 mm to 170 mm. The voltage outputted by the battery cells 115 of the battery block 110 can range 2 to 450V.

The battery block 110 can include or have at least one top conductive layer 120 and at least one bottom conductive layer 125. The top conductive layer 120 and the bottom conductive layer 125 can form part of an integrated current collector 135. The electrically conductive material for the top conductive layer 120 and the bottom conductive layer 125 can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others. Both the top conductive layer 120 and the bottom conductive layer 125 can be along one or more surfaces of the battery block 110 (e.g., along a top side as depicted). The top conductive layer 120 and the bottom conductive layer 125 can at least partially span across the one or more surfaces of the battery block 110. For example, both the top conductive layer 120 and the bottom conductive layer 125 can at least partially span the top surface of the battery block 110 as depicted. The top conductive layer 120 and the bottom conductive layer 125 can be parallel or substantially parallel to each other (e.g., deviation of 0° to 15°). A shape of the top conductive layer 120 and the bottom conductive layer 125 can be a prismatic casing with a polygonal base, such as a triangle, a square, a rectangular (e.g., as depicted), a pentagon, or a hexagon, among others. An overall shape of the top conductive layer 120 and the bottom conductive layer 125 can generally match an overall shape of one surface of the battery block 110, and can be a circular, ovular, or elliptical base, among others. The shapes of the top conductive layer 120 and the bottom conductive layer 125 can vary from one another. A thickness of each of the top conductive layer 120 and the bottom conductive layer 125 can be 0.5 mm to 5 mm. A width or diameter of each of the top conductive layer 120 and the bottom conductive layer 125 can match the width or the diameter of the battery block 110, and can be 150 mm to 170 mm. A length of each of the top conductive layer 120 and the bottom conductive layer 125 can match the width or the diameter of the battery block 110, and can be 150 mm to 170 mm.

The top conductive layer 120 and the bottom conductive layer 125 of the integrated current collector 135 can have or define a set of openings for the holders to house the battery cells 115. The openings defined on the top conductive layer 120 can be at least partially aligned with the openings defined on the bottom conductive layer 125. The openings defined on the bottom conductive layer 125 can be also at least partially aligned with the openings defined on the top conductive layer 120. Each opening defined on the top conductive layer 120 and the bottom conductive layer 125 can expose the positive terminal and the negative terminal of the battery cell 115 passing through the opening. At least a portion of the battery cells 115 when arranged or disposed in the battery block 110 can pass through the openings of both the top conductive layer 120 and the bottom conductive layer 125. A shape of each opening defined by the top conductive layer 120 and the bottom conductive layer 125 can generally match the shape of the battery cells 115. A shape of the opening can be a prismatic casing with a polygonal base, such as a triangle, square, a rectangular, a pentagon, or a hexagon. The shape of the openings defined on the top conductive layer 120 and the bottom conductive layer 125 can also be a circular (e.g., as depicted), ovular, or elliptical base, among others. A length of each opening can be 16 mm to 30 mm. A width or diameter of each opening can be 16 mm to 30 mm.

The top conductive layer 120 and the bottom conductive layer 125 can electrically couple to the set of battery cells 115 housed in the battery block 110 in parallel. The top conductive layer 120 and the bottom conductive layer 125 can define or can correspond to a positive terminal and a negative terminal for the battery block 110. The positive terminal for the battery block 110 can correspond to or can be electrically coupled with the positive terminals of the set of battery cells 115 in the battery block 110. The negative terminal for the battery block 110 can correspond to or can be electrically coupled with the negative terminals of the set of battery cells 115 in the battery block 110. Both the positive terminal and the negative terminal of the battery block 110 can be defined along one surface of the battery block 110 (e.g., along the top surface as depicted). The top conductive layer 120 and the bottom conductive layer 125 can correspond to opposite polarities of the battery block 110. For example, the top conductive layer 120 can correspond to the positive terminal of the battery block 110, and can be electrically coupled with the positive terminal of each battery cell 115 in the battery block 110. On the other hand, the bottom conductive layer 125 can correspond to the negative terminal of the battery block 110, and can be electrically coupled with the negative terminal of each battery cell 115 in the battery block 110. Conversely, the top conductive layer 120 can correspond to the negative terminal of the battery block 110, and can be electrically coupled with the negative terminal of each battery cell 115 in the battery block 110. On the other hand, the bottom conductive layer 125 can correspond to the positive terminal of the battery block 110, and can be electrically coupled with the positive terminal of each battery cell 115 in the battery block 110. The battery block 110 can have or define an electrical ground for the battery cells 115 contained therein. The electrical ground of the battery block 110 can be along one surface of the battery block 110 (e.g., along a bottom surface or a side wall). The surface defining the electrical ground can differ from the surface defining the positive terminal and the negative terminal for the battery block 110. In this manner, electrical power stored in the battery cells 115 can transverse along the top conductive layer 120 and the bottom conductive layer 125. Thus, voltage and current can be provided through the top conductive layer 120 and the bottom conductive layer 125 of the integrated current collector 135.

The top conductive layer 120 and the bottom conductive layer 125 can be electrically isolated from each other using at least one insulating layer. The insulating layer can be part of the integrated current collector 135. The insulating layer can electrically isolate the top conductive layer 120 and the bottom conductive layer 125. The top conductive layer 120 and the bottom conductive layer 125 can be physically separated from each other via the insulating layer. A top surface of the insulating layer can be partially flush with the top conductive layer 120. A bottom surface of the insulating layer can also be partially flush with the bottom conductive layer 125. Another insulating layer can electrically isolate the top conductive layer 120 from any portion of the battery cell 115 corresponding to the polarity terminal opposite of the top conductive layer 120. Another insulating layer can electrically isolate the bottom conductive layer 125 from any portion of the battery cell 115 corresponding to the polarity terminal opposite of the bottom conductive layer 125. For example, if the top conductive layer 120 corresponds to the positive terminal of the battery block 110, the insulating layer can electrically isolate the top conductive layer 120 from the negative terminal of the battery cells 115. In addition, the insulating layer can electrically isolate the bottom conductive layer 125 corresponding to the positive terminal from the positive terminal of the battery cells 115. The insulating layer can be an electrically insulating material. The electrically insulating material for the insulating layer can include a ceramic material (e.g., silicon nitride, silicon carbide, titanium carbide, zirconium dioxide, and beryllium oxide) and a thermoplastic material (e.g., acrylic glass, polyethylene, polypropylene, polystyrene, or polyvinyl chloride), among others.

The apparatus 100 can include at least one battery module 105. A set of battery blocks 110 can form the battery module 105. The battery module 105 can include at least one of the battery blocks 110 (e.g., four battery blocks 110 as depicted). A subset including at least two of the battery blocks 110 can form a submodule of the battery module 105. Each battery block 110 can be separate from one another within the battery module 105. Without any additional electrical coupling, the battery cells 115 in one battery block 110 can be electrically isolated from other battery blocks 110. Each battery block 110 of the battery module 105 can be disposed or arranged next to one another. The arrangement of the battery blocks 110 in the battery module 105 can be in parallel (e.g., as depicted) or in series, or any combination thereof. The battery module 105 can have or define a positive terminal and a negative terminal. The battery module 105 can include an additional connection element to electrically couple the battery cells 115 across multiple battery blocks 110. The positive terminal for the battery module 105 can correspond to or can be electrically coupled with the positive terminals of the set of battery cells 115 in the battery module 105 across the battery blocks 110. The negative terminal for the battery block 110 can correspond to or can be electrically coupled with the negative terminals of the set of battery cells 115 in the battery module 105 across the battery blocks 110. Both the positive terminal and the negative terminal of the battery module 105 can be defined along a top surface of the battery block 110. The top surface of the battery module 105 can be exposed (e.g., to air). An overall shape of the battery module 105 can depend on the arrangement and the individual shapes of the battery blocks 110. The dimensions of the battery module 105 can be a multiple of the dimensions of the battery blocks 110 (e.g., 8×1). A height of the battery module 105 can be 65 mm to 100 mm. A width or diameter of the battery module 105 can be 100 mm to 330 mm. A length of the battery module 105 can be 160 mm to 1400 mm. For example, when the battery module 105 includes two battery blocks 110, the length can be 160 mm and the width can be 700 mm. When the battery module 105 includes eight battery blocks 110 in series, the length can be 1400 mm and the width can be 330 mm.

The apparatus 100 can include at least one battery pack. The battery pack can include a set of battery modules 105. Each battery module 105 of the battery pack can be arranged or disposed adjacent to one another. The arrangement of the battery modules 105 in the battery pack can be in parallel or in series, or any combination thereof. To form the battery pack, the battery blocks 110 can be fastened, attached, or otherwise joined to one another. For example, a side wall of the battery blocks 110 can include interlocking joints to attach one battery module 105 to another battery module 105 to form the battery pack. In addition, the set of battery blocks 110 can be attached to one another using a fastener element, such as a screw, a bolt, a clasp, a bucket, a tie, or a clip, among others. The battery pack can have or define a positive terminal and a negative terminal. The positive terminal for the battery pack can correspond to or can be electrically coupled with the positive terminals of the set of battery cells 115 in the battery pack across the battery modules 105. The negative terminal for the battery module 105 can correspond to or can be electrically coupled with the negative terminals of the set of battery cells 115 in the battery pack across the battery modules 105. Both the positive terminal and the negative terminal of the battery pack can be defined or located along a top surface of the battery module 105. An overall shape of the battery pack can depend on the arrangement and the individual shapes of the battery blocks 110 and battery modules 105. A height of the battery pack can be 120 mm to 160 mm. A width or diameter of the battery pack can be 1400 mm to 1700 mm. A length of the battery pack can be 2100 mm to 2600 mm.

The apparatus 100 can include at least one sense circuit board 130 (referred herein sometimes as a “sense board,” “submodule sense board,” or “module sense board”). The sense circuit board 130 can be at least partially incorporated or integrated into at least one of the battery blocks 110 of the battery module 105. At least a portion of the sense circuit board 130 can be situated, disposed, or arranged along one surface of the battery block 110 of the battery module 105 (e.g., along the top surface as depicted). When disposed, at least one side of the sense circuit board 130 can be flush with the surface of the battery block 110. The sense circuit board 130 can be coplanar, parallel, or on a substantially parallel plane (e.g., with deviation of between 0° to) 15° as the top conductive layer 120 and the bottom conductive layer 125 of the integrated current collector 135. A single sense circuit board 130 can be incorporated into multiple battery blocks 110. A portion of the sense circuit board 130 can be incorporated or integrated with a first battery block 110 and another portion of the sense circuit board 130 can be incorporated or integrated with a second battery block 110. An overall shape of the sense circuit board 130 can be a circular, ovular, or elliptical based, among others. A thickness of the sense circuit board 130 can be 0.75 mm to 2 mm. A width or diameter of the sense circuit board 130 can be 40 mm to 60 m. A length of the sense circuit board 130 can be 300 mm to 400 mm.

The sense circuit board 130 can be a printed circuit board with an electrically insulating substrate. The electrically insulating substrate can be comprised of a dielectric composite material, such as a synthetic resin bonded paper (e.g., FR-1, FR-2, FR-4, CEM-1, CEM-4, Teflon, and RF-35). The substrate can be an insulated metal substrate with the set of voltage trace lines 140 defined therein. The sense circuit board 130 can have a set of voltage trace lines 140 defined or embedded along the electrically insulating substrate. The voltage trace lines 140 can be comprised of copper, aluminum, nickel, tin, lead, or gold, among others. The voltage trace lines 140 can be electrically coupled with various components of the battery module 105, such as the top conductive layer 120, the bottom conductive layer 125, or any of the battery cells 115 of different battery blocks 110. The voltage trace lines 140 can electrically couple the battery cells 115 of the battery blocks 110 of the battery module 105 with components external to the battery module 105 (e.g., a battery monitoring system). The voltage trace lines 140 can electrically couple the battery cells 115 of the battery blocks 110 of the battery module 105 with components within the battery module 105 (e.g., a battery monitoring unit incorporated into the integrated current collector). At least one voltage trace line 140 can be electrically coupled with the top conductive layer 120 of one of the battery blocks 110. At least one voltage trace line 140 can be electrically coupled with the bottom conductive layer 125 of one of the battery blocks 110. At least one voltage trace line 140 can electrically couple one of the top conductive layer 120 or the bottom conductive layer 125 of one of the battery blocks 110 with the component external to the battery block 110. At least one voltage trace line 140 can electrically couple one of the top conductive layer 120 or the bottom conductive layer 125 of one of the battery blocks 110 with the component internal to the battery module 105.

The sense circuit board 130 can have at least one connector 145. The connector 145 can define a port to couple with at least one component outside the sense circuit board 130 to relay at least one signal indicative of one or more characteristics of the components of the battery module 105. The connector 145 can have one or more connection elements to electrically couple the components of the sense circuit board 130 with at least one component outside the sense circuit board 130. The connection elements of the connector 145 can include a pin (e.g., as depicted), a lead, a surface mount, or a through-hole, among others. The connection elements can provide a physical connection and an electrical coupling between components of the sense circuit board 130 and the at least one component outside the sense circuit board 130. For example, the external component can be coupled with the connection elements of the connector 145 using a data harness. Via the coupling with the connector 145, the sense circuit board 130 can relay signals from the battery module 105 to the external component (e.g., a battery monitoring system) and can relay signals from the external component to the battery module 105.

The apparatus 100 can include at least one battery monitoring system (BMS) 150 external to the battery module 105. The BMS 150 can include at least one processor, at least one memory, at least one input/output (I/O) interface, and at least communication interface. The processors of the BMS 150 can be, for example, a field-programmable gate array (FPGA), a system on a chip (SOC), a microcontroller, or an application-specific integrated circuit (ASIC), or other logical circuitry, to carry out the functionalities detailed herein. The BMS 150 can include one or more components of a computing system 700 as detailed herein below. The one or more components of the BMS 150 can be positioned, distributed, arranged, or disposed in any manner relative to the battery module 105 or to the one or more battery blocks 110 of the battery module 105. The BMS 150 can be integrated to one or more of the battery blocks 110 of the battery module 105. The BMS 150 can be electrically coupled to components of the battery module 105 through the connector 145 and the set of voltage trace lines 140 of the sense circuit board 130 (e.g., using a data harness). The BMS 150 can receive signals from the components the battery module 105 via the sense circuit board 130. The BMS 150 can send signals to the components of the battery module 105 via the sense circuit board 130 to control the operations of the components of the battery module 105. The BMS 150 can receive signals from other components of the electric vehicle besides the battery module 105. The BMS 150 can send signals to the components of the electric vehicle.

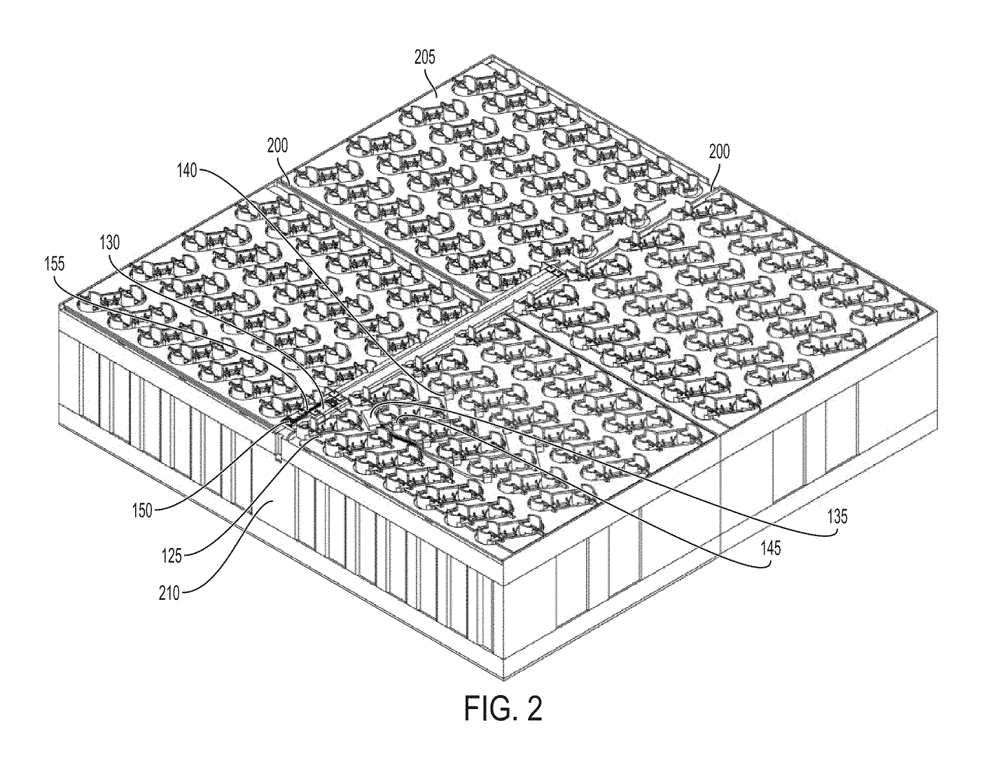

FIG. 2, among others, depicts an isometric view of an illustrative embodiment of the apparatus 100 for providing energy storage with component monitoring capability. As illustrated, the battery module 105 can define or have at least one joint structure 200. The joint structure 200 can be defined along between multiple battery blocks 110 of the battery module 105 (e.g., two battery blocks 110 as shown). The joint structure 200 can interlock, fasten, attach, or otherwise join one battery block 110 with another battery block 110. To form the battery module 105, the battery blocks 110 can be fastened, attached, or otherwise joined to one another via the joint structure 200. For example, a side wall of the battery blocks 110 can include interlocking joints to attached one battery block 110 to another battery block 110 to form the battery module 105. In addition, the set of battery blocks 110 can be attached to one another using a fastener element, such as a screw, a bolt, a clasp, a bucket, a tie, or a clip, among others. The joint structure 200 can extend one side of at least one battery block 110 joined with another side of at least one other battery block 110. At least a portion of the sense circuit board 130 can be situated, arranged, or otherwise disposed on the joint structure 200. A portion of a surface of the sense circuit board 130 can be flush with one surface (e.g., a top surface) of the joint structure 200. The sense circuit board 130 can be integrated with two or more battery blocks 110 by extension over the joint structure 200.

The battery module 105 can define or have at least one top surface 205 and at least one body 210. The body 210 can correspond to a portion of the battery module 105 below the bottom conductive layer 125 of the integrated current collector 135. The top surface 205 can correspond to the same side of the battery module 105 defining the positive terminal and the negative terminal of the battery blocks 110. The top surface 205 can be coplanar between multiple battery blocks 110 of the battery module 105 (e.g., as depicted). The top surface 205 can be in different substantially parallel planes (e.g., deviation within 0° to 15°) between the multiple battery blocks 110 of the battery module 105. The top surface 205 can correspond to the side of the battery pack 105 from which the battery block 110 and the battery cells 115 can extend. The body 210 of the battery module 105 can contain, support, house, or otherwise include a bottom portion of the battery block 110 below the top surface 205. Additionally, the body 210 of the battery module 105 can contain, support, house, or otherwise include a bottom portion of the battery cells 115 below the top surface 205. The body 210 can be comprised of an electrically insulating but thermally conductive material. The material for the body 210 of the battery module 105 can include a ceramic material (e.g., silicon nitride, silicon carbide, titanium carbide, zirconium dioxide, and beryllium oxide) and a thermoplastic material (e.g., acrylic glass, polyethylene, polypropylene, polystyrene, or polyvinyl chloride), among others. A top portion of the battery cells 115 of the battery blocks 110 can extend from the body 210 of the battery pack above the top surface 205. In addition, a top portion of the battery block 110 can extend from the body 210 of the battery module 105 above the top surface 205. At least a portion of the joint structure 200 can lie above the top surface 205.

The apparatus 100 can include at least one sensor to measure one or more characteristics of the components of the battery module 105. The sensor can be in direct contact with an outer surface of the component of the battery module 105 to be measured, such as the top conductive layer 120, the bottom conductive layer 125, the battery block 110, the individual battery cells 115, and the insulating layer among others. The sensor can be situated, arranged, or disposed within the battery module 105. For example, the sensor can be placed within the body 210 of the battery module 105. The sensor can be arranged or disposed within the battery block 110, such as the within the holders for supporting the battery cells 115. The sensor can be arranged or disposed along a surface of the battery module 105 or one the components therein, such as along the top surface 205 of the battery module 105, a side wall of the battery block 110, and a bottom surface of the battery module 105. The sensor can convey measurements to the sense circuit board 130 via the coupling with the sense circuit board 130. The sensor can convey measurements to the BMS 150 through the coupling with the sense circuit board 130 and voltage trace lines 140. The sensor can also convey the measurements to other components of the battery module 105.

The sensor can include a thermometer to measure a temperature of the battery module 105, the battery block 110, or the battery cells 115. The thermometer can include an infrared thermometer, a liquid crystal thermometer, a vapor pressure thermometer, a column block thermometer, and a thermocouple, a quartz thermometer, among others. The sensor coupled with the sense circuit board 130 can include at least one pressure gauge or a force meter to measure pressure exerted from within the battery blocks 110. The force meter can be a dynamometer, a newton meter, and a spring scale, among others to measure force exerted against an outer surface of the battery cell 115 or the battery block 110. The pressure gauge can include a hydrostatic pressure gauge (e.g., a piston gauge, a liquid column, and a McLeod gauge), a mechanical gauge (e.g., a bellow, a Bourdon gauge, and a diaphragm), an electronic pressure sensor (e.g., a capacitive sensor, an electromagnetic gauge, a piezoresistive strain gauge, and an optical sensor), and a thermal conductivity gauge (e.g., Pirani gauge), among others. The sensor can include a gas detector to identify one or more gaseous substances released from the battery block 110 or from the individual battery cells 115 in the battery block 110. The gas detector can also determine a concentration (measured in parts-per notation) of the one or more gaseous substances released from the battery block 110. The gaseous substances identified by the gas detector can include hydrocarbons, ammonia, carbides (e.g., carbon monoxide and carbon dioxide), cyanide, halide, sulfides (e.g., hydrogen sulfide, sulfur dioxide, sulfur trioxide, and disulfur monoxide), nitrides, fluorides (e.g., hydrogen fluoride and phosphoryl fluoride), volatile organic compounds (e.g., formaldehyde and benzene), and phosphites among others. The gas detector of the sensor can include an electrochemical gas sensor, a flame ionization detector, an infrared point sensor, a pellistor (e.g., catalytic bead sensor), thermal conductivity meter, and an ultrasonic gas leak detector, among others.

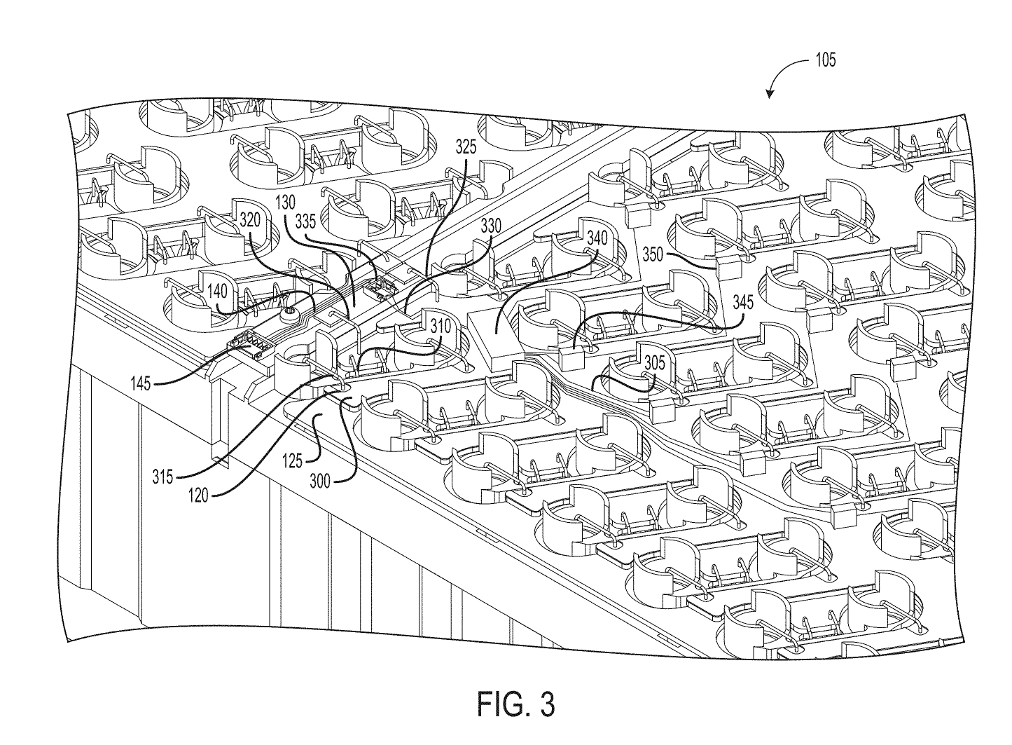

FIG. 3, among others, depicts an isometric and close-up view to a portion of an illustrative embodiment of the apparatus 100 for providing energy storage with component monitoring capability. As depicted, the battery block 110 can dispose, arrange, or otherwise have a circuit board layer 300. The circuit board layer 300 can be comprised of an electrically insulating material. The electrically insulating material for the circuit board layer 300 can include a ceramic material (e.g., silicon nitride, silicon carbide, titanium carbide, zirconium dioxide, and beryllium oxide), a thermoplastic material (e.g., acrylic glass, polyethylene, polypropylene, polystyrene, or polyvinyl chloride), or a dielectric composite material, such as a synthetic resin bonded paper (e.g., FR-1, FR-2, FR-4, CEM-1, CEM-4, Teflon, and RF-35), among others. The circuit board layer 300 can be part of the integrated current collector 135 of at least one of the battery blocks 110 of the battery module 105, together with the top conductive layer 120 and the bottom conductive layer 125. For example, one of the battery blocks 110 of the battery module 105 can include the circuit board layer 300 arranged on top of the integrated current collector 135, while the other battery blocks 110 of the battery module 105 can for instance lack the circuit board layer 300. The circuit board layer 300 can be parallel or substantially parallel (e.g., with deviations of 0° to 15°) to the top conductive layer 120 or the bottom conductive layer 125. The circuit board layer 300 can be along one or more surfaces of the battery block 110 (e.g., along a top side as depicted). The circuit board layer 300 can at least partially span across the one or more surfaces of the battery block 110. For example, both the circuit board layer 300 can at least partially span the top surface of the battery block 110 as shown. The circuit board layer 300 can be formed in the integrated current collector 135 above the top conductive layer 120 or the bottom conductive layer 125. For example, the circuit board layer 300 can be arranged in the battery block 110 above both the top conductive layer 120 and the bottom conductive layer 125 as depicted. At least a portion of the bottom surface of the circuit board layer 300 can be in contact or flush with the top conductive layer 120. At least another portion of the bottom surface of the circuit board layer 300 can be in contact or flush with the bottom conductive layer 125. A shape of the circuit board layer 300 can be a prismatic casing with a polygonal base, such as a triangle, a square, a rectangular (e.g., as depicted), a pentagon, or a hexagon, among others. An overall shape of the circuit board layer 300 can generally match an overall shape of one surface of the battery block 110, and can be a circular, ovular, or elliptical base, among others. A thickness of the circuit board layer 300 can be 0.5 mm to 5 mm. A width or diameter of the circuit board layer 300 can match a width or diameter of the battery block 110, and can be 150 mm to 170 mm. A length of the circuit board layer 300 can match a width or diameter of the battery block 110, and can be 150 mm to 170 mm.

The circuit board layer 300 of the integrated current collector 135 can have or define a set of openings for the holders to house the battery cells 115. The openings defined on the circuit board layer 300 can be at least partially aligned with the openings defined on the top conductive layer 120 and the bottom conductive layer 125, and vice versa. Each opening defined on the circuit board layer 300 can expose the positive terminal and the negative terminal of the battery cell 115 a portion of which can pass through the opening. At least a portion of the battery cells 115 when arranged or disposed in the battery block 110 can pass through the openings of the circuit board layer 300. A shape of each opening defined by the circuit board layer 300 can generally match the shape of the battery cells 115. A shape of the opening can be a prismatic casing with a polygonal base, such as a triangle, square, a rectangular, a pentagon, or a hexagon. The shape of the openings defined on the circuit board layer 300 can also be a circular (e.g., as depicted), ovular, or elliptical base, among others. A length of each opening can be 16 mm to 30 mm. A width or diameter of each opening can be 16 mm to 30 mm.

The apparatus 100 can include a set of conductive trace lines 305. Each conductive trace line 305 can be at least partially integrated or embedded into the integrated current collector 135 of at least one of the battery blocks 110 of the battery module 105. Each conductive trace line 305 can also be formed on the circuit board layer 300 of at least one battery block 110. For example, one of the battery blocks 110 of the battery module 105 can have the conductive trace lines 305 embedded in the circuit board layer 300 of the integrated current collector 135, while the other battery blocks 110 of the battery module 105 can lack the conductive trace lines 305. At least a portion of the conductive trace line 305 can span a surface (e.g. the top surface as depicted) of the circuit board layer 300. The conductive trace lines 305 can be comprised of an electrically conductive material. The electrically conductive material for the conductive trace lines 305 can include copper, aluminum, nickel, tin, lead, or gold, among others. The set of trace lines 305 can be electrically coupled with various components arranged or disposed in the battery module 105, such the top conductive layer 120, the bottom conductive layer 125, and the battery cells 115 of the same battery block 110 or different battery blocks 110.

At least one trace line 305 can be electrically coupled with the top conductive layer 120. The conductive trace line 305 coupled with the top conductive layer 120 can traverse or pass from one surface of the circuit board layer 300 flush with the top conductive layer 120 to connect with a surface of the top conductive layer 120. One end of the conductive trace line 305 can be connected with the top conductive layer 120 via wire bonding, ball bonding, compliant bonding, or direct contact, among others. At least one trace line 305 can be electrically coupled with the bottom conductive layer 125. The conductive trace line 305 coupled with the bottom conductive layer 125 can traverse or pass from one surface of the circuit board layer 300 flush with the bottom conductive layer 125 to connect with a surface of the bottom conductive layer 125. In connecting with the surface of the bottom conductive layer 125, the conductive trace line 305 can also traverse or pass through an opening defined on the top conductive layer 120. The opening can electrically isolate the conductive trace line 305 from the top conductive layer 120. The conductive trace line 305 can also bypass the top conductive layer 120, for example, on a portion of the circuit board layer 300 flush with the bottom conductive layer 125 but not the top conductive layer 120. One end of the conductive trace line 305 can be coupled with the bottom conductive layer 125 via wire bonding, ball bonding, compliant bonding, or direct contact, among others. The one or more trace lines 305 electrically coupled with the top conductive layer 120 can be electrically isolated from the one or more trace lines 305 coupled with the bottom conductive layer 125.

At least one trace line 305 can be electrically coupled with the sensor disposed in the battery block 110. The conductive trace line 305 can traverse or pass from one surface of the circuit board layer 300 to the other surface of the circuit board layer 300 to connect with the sensor disposed within the body of the battery module 105. The conductive trace line 305 can also traverse or pass through an opening (e.g., a via) defined in the top conductive layer 120 or an opening defined in the bottom conductive layer 125 to connect with the sensor disposed within the body 210 of the battery module 105. The conductive trace line 305 can be connected to the sensor disposed on the side wall of the battery module 105 via a connector element. One end of the conductive trace line 305 can be connected to the sensor via wire bonding, ball bonding, compliant bonding, or direct contact, among others. The one or more trace lines 305 coupled to the sensor can be electrically isolated from the one or more trace lines 305 coupled to the top conductive layer 120 or the bottom conductive layer 125.

The apparatus 100 can include a set of connector elements to electrically couple components of the battery module 105. The set of connector elements can include at least one first connector element 310, at least one second connector element 315, at least one third connector element 320, at least one fourth connector element 325, and at least one fifth connector element 330, among others. Each connector element can be an electrically conductive conduit (e.g., a wire) to electrically couple one component of the battery module 105 to another component. One end of the connector element can be connected to one component via wire bonding, ball bonding, compliant bonding, or direct contact, among others. Another end of the connector element can be connected to another component different from the other end via wire bonding, ball bonding, compliant bonding, or direct contact, among others. At least portion of the connector element between the two ends can be suspended above the battery module 105 (e.g., in the air as shown). The electrically conductive material for the connector elements can include a metallic material, such as aluminum, an aluminum alloy with copper, silicon, tin, magnesium, manganese or zinc (e.g., of the aluminum 1000, 4000, or 5000 series), iron, an iron-carbon alloy (e.g., steel), silver, nickel, copper, and a copper alloy, among others.

The at least one first connector element 310 and the at least one second connector element 315 can facilitate electrical coupling within a single battery block 110. The first connector elements 310 can connect one of polarity terminals of the battery cells 115 housed in the battery block 110 with the top conductive layer 120 to electrically couple the polarity terminal of the battery cells 115 with the top conductive layer 120. The first connector element 310 can be connected with the positive terminals of the battery cells 115 to define the top conductive layer 120 as the positive terminal of the battery block 110. The first connector element 310 can be connected with the negative terminals of the battery cells 115 to define the top conductive layer 120 as the negative terminal of the battery block 110. In addition, the second connector elements 315 can connect one of polarity terminals of the battery cells 115 housed in the battery block 110 with the bottom conductive layer 125 to electrically couple the polarity terminal of the battery cells 115 with the bottom conductive layer 125. The second connector element 315 can be connected to the opposite polarity terminal as the first connector element 310. The second connector element 315 can be connected with the positive terminals of the battery cells 115 to define the bottom conductive layer 125 as the positive terminal of the battery block 110. The second connector element 315 can be connected with the negative terminals of the battery cells 115 to define the bottom conductive layer 125 as the negative terminal of the battery block 110.

The at least one third connector element 320 and the at least one fourth connector element 325 can facilitate electrical coupling between different battery blocks 110 of the battery module 105. The third connector elements 320 and the fourth connector elements 325 can be connected to different voltage trace lines 140 embedded in the sense circuit board 130. As discussed above, the voltage trace lines 140 can electrically couple components of the battery module 105 across different battery blocks 110, such as the top conductive layers 120, the bottom conductive layers 125, and the battery cells 115 housed in the battery blocks 110. The third connector element 320 can connect the top conductive layer 120 with at least one of the voltage trace lines 140 of the sense circuit board 130. Third connector element 320 can electrically couple the BMU 340 with one of the top conductive layer 120 or the bottom conductive layer 125 of another battery block 110 via the voltage trace lines 140 of the sense circuit board 130. The third connector element 320 can electrically couple the top conductive layer 120 of one battery block 110 with a component external to the battery block 110 (e.g., BMS 150). The fourth connector element 325 can connect the bottom conductive layer 125 with at least one of the voltage trace lines 140 of the sense circuit board 130. Fourth connector element 325 can electrically couple the bottom conductive layer 125 with one of the top conductive layer 120 or the bottom conductive layer 125 of another battery block 110 via the voltage trace lines 140 of the sense circuit board 130. The fourth connector element 325 can electrically couple the bottom conductive layer 125 of one battery block 110 with a component external to the battery block 110 (e.g., BMS 150).

The at least one fifth connector element 330 can facilitate connections between trace lines 305 of the circuit board layer 300 with the voltage trace lines 140 of the sense circuit board 130. The fifth connector element 330 can connect at least one of the embedded trace lines 305 of the circuit board layer 300 with at least one of the voltage trace lines 140 of the sense circuit board 130. By connecting with the voltage trace line 140, the fifth connector element 330 can electrically couple the embedded trace line 305 with one of the top conductive layer 120 or the bottom conductive layer 125 of another battery block 110. Through the connection with the voltage trace line 140, the fifth connector element 330 can electrically couple the embedded trace line 305 with the connector 145. The fifth connector element 330 can electrically couple the embedded trace line 305 with a component external to the battery module 105 via the connector 145. To connect with the at least one fifth connector element 330, the sense circuit board 130 can include a port 335. The port 335 can include one or more connection elements. The port 335 can have one or more connection elements to electrically couple the components of the sense circuit board 130 with the fifth connector element 330. The connection elements of the port 335 can include a pin (e.g., as depicted), a lead, a surface mount, a contact path, or a through-hole, among others. The fifth connector element 330 can be connected with the port 335 wire bonding, ball bonding, compliant bonding, or direct contact. The voltage trace lines 140 connected to the port 335 can be connected with the connector 145 to electrically couple with at least one component external to the battery module 105. Via the coupling with the port 335, the sense circuit board 130 can relay signals from the battery module 105 to the external component (e.g., BMS 150) and can relay signals from the external component to the battery module 105.

The apparatus 100 can include a set of electrical impedance components. The set of electrical impedance components can include for instance one or more resistors 345, one or more capacitors 350, and one or more inductors, among others. The electrical impedance components can be fixed with a fixed impedance value (e.g., fixed resistance, capacitance, or inductance). The electrical impedance components with fixed impedance values (e.g., fixed resistors, fixed capacitors, or fixed inductors) can have two pins. A first pin can be for one polarity terminal (e.g., positive) and a second pin can be for the other polarity terminal (e.g., negative). The electrical impedance components can be variable with a variable impedance value (e.g., variable resistance, capacitance, or inductance). The electrical impedance components with variable impedance values (e.g., variable resistors, variable capacitor, or variable inductors) can have three pins. A first pin can be for one polarity terminal (e.g., positive). A second pin can be for the other polarity terminal (e.g., negative). A third pin can be for a control pin to set or adjust the impedance value of the electrical impedance component. The third pin can be coupled to an actuator to set the impedance value. The resistors 345 can draw voltage and current from the battery cells 115 of the battery block 110. The resistors 345 can be a fixed resistor (e.g., a carbon composite, carbon pile resistor, a carbon film, a metal oxide, and a through-hole resistor, among others) or a variable resistor (e.g., an adjustable resistor or potentiometer), among others. The resistance value can range from 50Ω to 100Ω. The capacitors 350 can protect battery cells 115 surges in current or voltage from other battery cells 115. The capacitors 350 can be a fixed capacitor (e.g., an air-gap capacitor, a ceramic capacitor, a film capacitor, a polymer capacitor, a mica capacitor, and a silicon capacitor), a polarized capacitor (e.g., an aluminum electrolytic capacitor, a niobium electrolytic capacitor, a tantalum electrolytic capacitor, and a lithium-ion capacitor), or a variable capacitor (e.g., an air-gap tuning capacitor, a vacuum tuning capacitor, an air-gap trimmer capacitor, and a ceramic-trimmer capacitor), among others. The capacitance value can range from 0 to 10 μF. The inductors can be fixed or variable, and can include air-core inductors, ferromagnetic-core inductors, and variable inductors, among others. The inductance value can range from 0 to 10 μH.

Each electrical impedance component can be arranged or disposed on the integrated current collector 135. Each electrical impedance component can be arranged or disposed along a surface of the circuit board layer 300. The electrical component components can be spatially distributed along one or more surfaces of the circuit board layer 300 (e.g., the top surface of the circuit board layer 300 as depicted). To minimize or optimize on a length of the electrical conductive trace lines 305 spanning the circuit board layer 300, a location of each electrical impedance component can be disposed or arranged to be within a distance with a location of another electrical impedance component or another component on the battery block 110 or battery module 105. The other components of the battery block 110 or the battery module 105 can include the battery cells 115, the sense circuit board 130, or a battery monitoring unit 340. The spatial distance between the electrical impedance components with one another or with another component of the battery block 110 can range from a 5 cm to 1 m for instance. At least a portion or an entirety of the electrical trace lines 305 connecting the electrical impedance components with other components can span within the distance along the circuit board layer 300.

Each electrical impedance component can be electrically coupled with the top conductive layer 120 or the bottom conductive layer 125. Each electrical impedance component can be electrically coupled with at least one of the conductive trace lines 305. The coupling of the electrical impedance components with the top conductive layer 120, the bottom conductive layer 125, and the conductive trace lines 305 can be in parallel or in series. At least one end of the conductive trace line 305 can be electrically coupled with one or more pins of the electrical impedance component. One end of the conductive trace line 305 can be connected with the one or more pins of the electrical impedance component via wire bonding, ball bonding, compliant bonding, or direct contact, among others. Multiple electrical impedance components can be connected in series on the circuit board layer 300 using the conductive trace lines 305. To couple in series, one pin of a first electrical impedance component (e.g., the resistor 345 or the capacitor 350) can be connected to one of the top conductive layer 120 or the bottom conductive layer 125. The pin of the electrical impedance component can be connected to the top conductive layer 120 or the bottom conductive layer 125. The other pin of the first electrical impedance component can be connected to the conductive trace line 305. One pin of a second electrical impedance component can be connected to the conductive trace line 305 to couple with the first electrical impedance component. The other pin of the second impedance component can be connected to another component on the circuit board layer 300 via another conductive trace line 305. For example, as depicted, a capacitor 350 can have one pin coupled to the top conductive layer 120 or the bottom conductive layer 125 of the integrated current collector 135. The capacitor 350 can have another pin connected to one of the conductive trace lines 305 to electrically couple the capacitor to the conductive trace line 305. At the other end, the conductive trace line 305 can be connected to one pin of the resistor 345 to electrically couple the capacitor 350 to the resistor 345. The resistor 345 can have another pin connected to another conductive trace line 305 to couple with another component disposed on the circuit board layer 300. To couple in parallel, the electrical impedance component (e.g., the resistor 345 or the capacitor 350) can have one pin connected with the top conductive layer 120 to electrically couple with the top conductive layer 120. The electrical impedance component can have another pin connected with the bottom conductive layer 125 to electrically couple with the bottom conductive layer 125.

The apparatus 100 can include at least one battery monitoring unit (BMU) 340. The BMU 340 can include at least one processor, at least one memory, at least one input/output (I/O) interface, and at least communication interface. The processors of the BMU 340 can be, for example, a field-programmable gate array (FPGA), a system on a chip (SOC), a microcontroller, or an application-specific integrated circuit (ASIC), or other logical circuitry, to carry out the functionalities detailed herein. The BMU 340 can include one or more components of a computing system 700 as detailed herein below. The BMU 340 can be at least partially incorporated into the integrated current collector 135. The BMU 340 can be at least partially disposed or arranged on the circuit board layer 300 of the integrated current collector 135. The components of the BMU 340 can be arranged or disposed in one location on the circuit board layer 300 of the battery block 110. For example, as depicted, the BMU 340 can all be located in a single housing on a single location along the top surface of the circuit board layer 300. The components of the BMU 340 can be spatially distributed throughout the circuit board layer 300 of the battery block 110. For example, the processors of the BMU 340 can be arranged in one location on the circuit board layer 300, while the communication interface of the BMU 340 can be located decimeters or centimeters away in another location on the circuit board layer 300. The components of the BMU 340 can be disposed or arranged on the circuit board layer 300 arranged in one of the battery blocks 110 of the battery module 105. The other battery blocks 110 of the battery module 105 can lack the components of the BMU 340. For example, as depicted, the BMU 340 can be located on the battery module 105 generally on the right of FIG. 3, while the battery module 105 generally on the left may lack a BMU 340.

The BMU 340 can be electrically coupled with various components of the battery module 105 and components external to the battery module 105 (e.g., the BMS 150) via the set of conductive trace lines 305. The BMU 340 can have one or more inputs to obtain at least one measurement signal from one or more components of the battery module 105 and components external to the battery module 105 via the set of conductive trace lines 305. Each measurement signal can be indicative of a characteristic of the component of the battery block 110, the battery module 105, or the individual battery cells 115, such as voltage, current, temperature, pressure, and presence of gaseous substances, among others. The BMU 340 can have one or more inputs to receive at least one control signal to control or change operations of the components of the battery block 110 from components external to the battery block 110 (e.g., another BMU 340 on another battery block 110 or the BMS 150). The control signal can specify an increase in voltage or current drawn from the battery cell 115 of the battery block 110 and a decrease in voltage or current drawn from the battery cells 115 of the battery block 110, among others. The BMU 340 can have one or more outputs to relay at least one measurement signal from the one or more components of the battery module 105 to another component (e.g., another BMU 340 on another battery block 110 or the BMS 150). The BMU 340 can have one or more outputs to control or change operations of the components of the battery block 110. Each input and output of the BMU 340 can correspond to an input pin of the processor or integrated circuit for the BMU 340. One end of trace line 305 can be connected to the input of the BMU 340 via wire bonding, ball bonding, compliant bonding, or direct contact, among others. The other end of the conductive trace line 305 can be connected to various components of the battery block 110 to provide an electrical coupling between the components of the battery block 110 with the input of the BMU 340.

To acquire characteristics of the components within the battery module 105, the inputs of the BMU 340 can be electrically coupled with components of the same battery block 110 that the BMU 340 is disposed on. At least one input of the BMU 340 can be electrically coupled with the top conductive layer 120 via the one or more conductive trace lines 305 connected to both the top conductive layer 120 and the input of the BMU 340. The input of the BMU 340 electrically coupled with the top conductive layer 120 can acquire the signal indicative of the voltage or the current drawn from the individual battery cells 115 of the battery block 110. At least one input of the BMU 340 can be electrically coupled with the bottom conductive layer 125 via the one or more conductive trace lines 305 connected to both the bottom conductive layer 125 and the input of the BMU 340. The input of the BMU 340 electrically coupled with the bottom conductive layer 125 can acquire the signal indicative of the voltage or the current drawn from the individual battery cells 115 of the battery block 110. At least one input of the BMU 340 can be electrically coupled with at least one of the sensors disposed in the battery module 105 via the one or more conductive trace lines 305 connected to the sensors and the input of the BMU 340. The input of the BMU 340 electrically coupled with the sensor can acquire the signal indicative of the temperature, pressure, or presence of gaseous substances as measured by the sensor disposed in the battery module 105.

The inputs of the BMU 340 can be electrically coupled with components outside the battery block 110 that the BMU 340 is disposed to obtain characteristics of the components of the other battery blocks 110. As discussed above, some of the battery blocks 110 in the battery module 105 may lack the BMU 340, while at least one of the battery blocks 110 in the battery module 105 can be arranged or disposed with the BMU 340. At least one input of the BMU 340 can be electrically coupled with the sense circuit board 130 via the conductive trace line 305 connected to the sense circuit board 130 via the fifth connector element 330. The fifth connection element 330 can electrically couple the input of the BMU 340 to the components of the other battery block 110 via the one or more voltage trace lines 140 connected to the other battery blocks 110. Through the coupling with the voltage trace lines 140 of the sense circuit board 130, the input of the BMU 340 can acquire the signals relayed from the components of the battery blocks 110, such as the top conductive layer 120, the bottom conductive layer 125, or the sensors disposed in the battery block 110. At least one signal can indicate the voltage and the current drawn from the battery cells 115 of the other battery block 110. Via the coupling with the top conductive layer 120 or the bottom conductive layer 125 of the other battery block 110, the input of the BMU 340 can be electrically coupled with the positive terminal or the negative terminal of the other battery block 110 to acquire the voltage or the current drawn from the battery cells 115 of the other battery block 110. At least one signal can indicate the temperature, pressure, and presence of gaseous substances as measured by the one or more sensors disposed in the other battery block 110.

The outputs of the BMU 340 can be electrically coupled with the components of the battery block 110 that the BMU 340 is disposed on via the one or more trace lines 305 to control operations of the components of the battery block 110, such as the battery cells 115. The outputs and inputs of the BMU 340 electrically coupled to the same component can share the same conductive trace line 305 to reduce space on the surface of the circuit board layer 300. The outputs and the inputs of the BMU 340 electrically coupled to the same component can be connected to different conductive trace lines 305 to allow for quicker relaying of signals. At least one output of the BMU 340 can be electrically coupled with at least one of the set of electrical impedance components (e.g., the resistor 345 or the capacitor 350) disposed on the circuit board layer 300 via the trace lines 305. The conductive trace line 305 can be connected with both the output of the BMU 340 and one of the pins of the electrical impedance component (e.g., the resistor 345 or the capacitor 350). For an electrical impedance component with fixed impedance (e.g., fixed resistors, fixed capacitors, or fixed inductors), the conductive trace line 305 extending from the output of the BMU 340 can be coupled to a polarity terminal pin (e.g., positive or negative) of the electrical impedance component. The other polarity terminal pin of the electrical impedance component can be connected to one of the top conductive layer 120 or the bottom conductive layer 125, or another component (e.g., another electrical impedance component) via another trace line 305. For an electrical impedance component with variable impedance (e.g., variable resistors, variable capacitors, or variable inductors), the conductive trace line 305 extending from the output of the BMU 340 can be connected with a control pin of the electrical impedance component. The other two pins of the electrical impedance component with variable impedance can correspond to the polarity terminals of the electrical impedance component. The other two pins can be connected with the top conductive layer 120 or the bottom conductive layer 125, or to another electrical impedance component via the conductive trace lines 305.

Using the characteristics of the components of the battery module 105, the BMU 340 can control or set the operations of the components of the battery module 105 via the one or more outputs of the BMU 340. Based on the characteristics, the BMU 340 can set, adjust, or otherwise control the voltage or current outputted by the battery cells 115 of the battery block 110 that the BMU 340 is disposed on, using the set of electrical impedance components (e.g., the resistors 345 and capacitors 350). The BMU 340 can compare the measured characteristics of the components of the battery block 110 to normal operations of the battery block 110. The measured characteristics can include voltage and current drawn from the battery cells 115 of the battery block 110, the temperature of heat radiating from the battery block 110, the pressured exerted from within the battery block 110, and the presence of gaseous substances released from the battery block 110. The normal operations can specify a range of characteristics to maintain a level of performance of the battery cells 115 of the battery block 110. For example, the normal operations can specify an output voltage of 2V per battery cell 115 (or 2V to 5V for the entire battery block 110), an output current of 50 mA to 3 Å per battery cell, a temperature range of 0° C. to 45° C., no presence of gaseous substances beside atmospheric gases (e.g., oxygen, carbon dioxide, and nitrogen), and an internal pressure of less than 100 kPa, among others. Based on the comparison, the BMU 340 can determine whether the measured characteristics are within the range of characteristics for the normal operations of the battery block 110.

The BMU 340 can determine that one or more of the measured characteristics are greater than the range of characteristics specified for normal operations of the battery block 110. Responsive to the determination, the BMU 340 can control the set of electrical impedance components (e.g., the resistor 345 and the capacitor 350) to lower the measured characteristics to within the range of characteristics specified for normal operations. For example, the BMU 340 can determine that the measured voltage and current drawn from the battery cells 115 of the battery block 110 are greater than the voltage or current specified for normal operations. Such a measured voltage can be indicative of over-voltage and such a measured current can be indicative of over-current in the battery cells 115 of the battery block 110. The BMU 340 can also determine that the measured temperature radiating from the battery block 110 is greater than the temperature specified for normal operations. Furthermore, the BMU 340 can determine that the measured pressure exerted from the battery block 110 is greater than the pressure specified for normal operations. The BMU 340 can also determine that the presence of gaseous substance differs from the gaseous substances specified for normal operation. Such a measured temperature or pressure or presence of gaseous substances can also be indicative of the over-voltage or over-current in the battery cells 115 of the battery block 110.

Responsive to any of these determinations, the BMU 340 can control the set of electrical impedance components (e.g., the resistor 345 and the capacitor 350) to absorb the excess voltage or adjust the current outputted by the battery cells 115 of the battery block 110. For electrical impedance components with fixed impedance, the BMU 340 can switch the electrical impedance component (e.g., the resistor 345 and the capacitor 350) coupled with the output of the BMU 340 via the conductive trace lines 305 from disconnected to connected. The switching can be performed by completing the circuit for the electrical impedance component through the BMU 340. When connected to the BMU 340 (e.g., in a closed circuit state) via the conductive trace lines 305, the electrical impedance component can be in an on state. When disconnected from the BMU 340 (e.g., in an open circuit state) via the conductive trace lines 305, the electrical impedance component can be in an off state. For electrical impedance components with variable impedance (e.g., the resistor 345 and the capacitor 350), the BMU 340 can determine an impedance value based on the measured voltage and the current outputted from the battery cells 115 of the battery block 110. As the measured voltage and the current can be greater than the voltage and current specified for normal operation, the determined impedance value can be greater than the previous impedance value. The BMU 340 can set the impedance value of electrical impedance component by sending the signal specifying the impedance value to the control pin of the electrical impedance component. In this manner, excess voltage or current from the battery cells 115 of the battery block 110 can be drawn by the electrical impedance components, such as the resistors 345 and the capacitors 350.

The BMU 340 can determine that one or more of the measured characteristics are less than the range of characteristics specified for normal operations of the battery block 110. Responsive to the determination, the BMU 340 can control the set of electrical impedance components (e.g., the resistor 345 and the capacitor 350) to increase the measured characteristics to within the range of characteristics specified for normal operations. For example, the BMU 340 can determine that the measured voltage and current drawn from the battery cells 115 of the battery block 110 are less than the voltage and current specified for normal operations. Such a measured voltage can be indicative of under-voltage and such a measured current can be indicative of under-current in the battery cells 115 of the battery block 110. The BMU 340 can also determine that the measured temperature radiating from the battery block 110 is less than the temperature specified for normal operations. Furthermore, the BMU 340 can determine that the measured pressure exerted from the battery block 110 is less than the pressure specified for normal operations. Such a measured temperature or pressure can also be indicative of the under-voltage or under-current in the battery cells 115 of the battery block 110.

Responsive to any of these determinations, the BMU 340 can control the set of electrical impedance components (e.g., the resistor 345 and the capacitor 350) to allow more voltage or current to be released from the battery cells 115 of the battery block 110. For electrical impedance components with fixed impedance, the BMU 340 can switch the electrical impedance component (e.g., the resistor 345 and the capacitor 350) coupled with the output of the BMU 340 via the conductive trace lines 305 from on to off. The switching can be performed by opening the circuit for the electrical impedance component through the BMU 340. For electrical impedance components with variable impedance (e.g., the resistor 345 and the capacitor 350), the BMU 340 can determine an impedance value based on the measured voltage and the current outputted from the battery cells 115 of the battery block 110. As the measured voltage and the current can be less than the voltage and current specified for normal operation, the determined impedance value can be less than the previous impedance value. The BMU 340 can set the impedance value of electrical impedance component by sending the signal specifying the impedance value to the control pin of the electrical impedance component. In this manner, more voltage or current can be configured on the battery cells 115 of the battery block 110.

The BMU 340 can determine that one or more of the measured characteristics are within the range of characteristics specified for normal operations of the battery block 110. Responsive to the determination, the BMU 340 can balance the voltage and currents outputted by the battery cells 115 across multiple battery blocks 110 of the battery module 105. The BMU 340 can compare the voltage and current outputted by the battery block 110 that the BMU 340 is disposed on with the voltage and current outputted by the other battery blocks 110. The BMU 340 can determine a difference between the voltage and current outputted by the battery block 110 that the BMU 340 is disposed on versus the voltage and current outputted by the other battery blocks 110. The BMU 340 can determine that the voltage and current drawn from the battery cells 115 of the battery block 110 that the BMU 340 is disposed on is greater than the voltage and current drawn from the battery cells 115 of one or more of the other battery blocks 110. Responsive to the determination, the BMU 340 can control the set of electrical impedance components (e.g., the resistor 345 and the capacitor 350) to absorb the excess voltage or current outputted by the battery cells 115 of the battery block 110. For electrical impedance components with fixed impedance, the BMU 340 can switch the electrical impedance component (e.g., the resistor 345 and the capacitor 350) coupled with the output of the BMU 340 via the conductive trace lines 305 from off to on. For electrical impedance components with variable impedance (e.g., the resistor 345 and the capacitor 350), the BMU 340 can set the impedance value of electrical impedance component by sending a signal specifying a higher impedance value to the control pin of the electrical impedance component. The BMU 340 can control the set of electrical impedance components based on a command signal received from another component (e.g., the BMS 150).

Conversely, the BMU 340 can determine that the voltage and current drawn from the battery cells 115 of the battery block 110 that the BMU 340 is disposed on is less than the voltage and current drawn from the battery cells 115 of one or more of the other battery blocks 110. Responsive to the determination, the BMU 340 can control the set of electrical impedance components (e.g., the resistor 345 and the capacitor 350) to release or allow more voltage or current from the battery cells 115 of the battery block 110. For electrical impedance components with fixed impedance, the BMU 340 can switch the electrical impedance component (e.g., the resistor 345 and the capacitor 350) coupled with the output of the BMU 340 via the conductive trace lines 305 from connected to disconnected. For electrical impedance components with variable impedance (e.g., the resistor 345 and the capacitor 350), the BMU 340 can set the impedance value of electrical impedance component by sending a signal specifying a lower impedance value to the control pin of the electrical impedance component. The BMU 340 can control the set of electrical impedance components based on a command signal received from another component (e.g., the BMS 150).

In addition, the outputs of the BMU 340 can be electrically coupled with components external to the battery block 110 that the BMU 340 is disposed on to relay the signals indicative of the characteristics of the components of the battery block 110. At least one output of the BMU 340 can be electrically coupled with the sense circuit board 130 via the trace lines 305 connected to the fifth connection element 330 and the output of the BMU 340. The fifth connection element 330 can electrically couple the output of the BMU 340 to the connector 145 via the voltage trace lines 140 to couple with one or more components external to the battery module 105, such as the BMS 150. Through the coupling from the BMU 340 to the BMS 150, the output of the BMU 340 can relay the signals indicative of the characteristics of the components of the battery block 110 to the external components via the conductive trace lines 305 and the sense circuit board 130. From the inputs connected to the top conductive layer 120 or the bottom conductive layer 125, the output of the BMU 340 can relay one or more signals indicative of the voltage and the current outputted by the battery cells 115 of the battery block 110 to the external components. From the inputs connected to the sensors disposed in the battery block 110, the output of the BMU 340 can relay one or more signals indicative of the temperature, pressure, and presence of gaseous substances as measured by the sensor to the external components.

Coupled with at least one sense circuit board 130, the BMS 150 can receive the signal indicative of the characteristics of the components of the battery module 105. The signal can be relayed from the BMU 340 disposed on one of the battery blocks 110 of the battery module 105. The signal can be acquired from the sense circuit board 130 coupled to the top conductive layers 120 or the bottom conductive layers 125 of one or more of the battery blocks 110 of the battery module 105 via the connector elements. Using the received signal from the battery block 110, the BMS 150 can calculate or determine one or more performance metrics of the entire battery module 105 or the battery pack including multiple battery modules 105. In calculating the performance metrics for the entire battery module 105 or the battery pack, the BMS 150 can apply extrapolation techniques on the measurements included in the received signal. The performance metrics can include a total voltage, a total current, a total pressure, and presence of all the gaseous substances, among others. The BMS 150 can determine the total voltage drawn from the battery module 105 or the battery pack using the measured voltage from the battery cells 115 as indicated in the received signal. The BMS 150 can determine the total current drawn from the battery module 105 or the battery pack based on the measured current drawn from the battery cells 115 as indicated in the received signal. The BMS 150 can determine the total temperature from heat radiating from the battery module 105 or the battery pack using the measured heat from at least one of the battery blocks 110. The BMS 150 the total pressure from the battery module 105 or the battery pack based on the measured pressured from at least one of the battery blocks 110. The BMS 150 can identify a presence of all the gaseous substances detected in the battery module 105 or the battery pack based on the gaseous substances detected the battery blocks 110. The BMS 150 can perform all or some of the functionalities detailed herein with respect the BMU 340 and various components of the battery module 105. The BMS 150 can compare the measured characteristics of the components of the battery block 110 to normal operations of the battery block 110. The normal operations can specify a range of characteristics to maintain a level of performance of the battery cells 115 of the battery block 110 on which the BMU 340 is disposed. Based on the comparison, the BMS 150 can determine whether the measured characteristics are within the range of characteristics for the normal operations of the battery block 110.

The BMS 150 can determine that one or more of the measured characteristics are greater than the range of characteristics specified for normal operations of the battery block 110. For example, the BMS 150 can determine that the measured voltage and the current outputted by the battery cells 115 of the battery block 110 on which the BMU 340 is disposed is greater than the voltage and current specified for normal operations. Responsive to the determination, the BMS 150 can send a command signal to the BMU 340 to decrease the voltage and current drawn from the battery cells 115 of the battery block 110. The command signal can be relayed via the connector 145, the voltage trace lines 140 of the sense circuit board 130, the fifth connector element 330, and the conductive trace lines 305 of the circuit board layer 300. Conversely, the BMS 150 can determine that one or more of the measured characteristics are less than the range of characteristics specified for normal operations of the battery block 110. For example, the BMS 150 can determine that the measured voltage and the current outputted by the battery cells 115 of the battery block 110 on which the BMU 340 is disposed is greater than the voltage and current specified for normal operations. Responsive to the determination, the BMS 150 can send a command signal to the BMU 340 to increase the voltage and current drawn from the battery cells 115 of the battery block 110. The command signal can be relayed via the connector 145, the voltage trace lines 140 of the sense circuit board 130, the fifth connector element 330, and the conductive trace lines 305 of the circuit board layer 300.

In addition, the BMS 150 can determine that the one or more characteristics are within the range of characteristics specified for normal operations of the battery block 110. Responsive to the determination, the BMS 150 can balance the voltage and currents outputted by the battery cells 115 across multiple battery blocks 110 of the battery module 105. The BMS 150 can compare the voltage and current outputted by the battery block 110 that the BMU 340 is disposed on with the voltage and current outputted by the other battery blocks 110. The BMS 150 can calculate or determine a difference in the voltage and current outputted by the battery cells 115 among the battery blocks 110. The BMS 150 can determine that the voltage and current drawn from the battery cells 115 of the battery block 110 that the BMU 34 is disposed on is greater than the voltage and current drawn from the battery cells 115 of one or more of the other battery blocks 110. Responsive to the determination, the BMS 150 can send a command signal to decrease the voltage and current drawn from the battery cells 115 of the battery block 110 that the BMS 150 is disposed on by the difference. The command signal can be relayed via the voltage trace lines 140 of the sense circuit board 130, the fifth connector element 330, and the conductive trace lines 305 of the circuit board layer 300. On the other hand, the BMS 150 can determine that the voltage and current drawn from the battery cells 115 of the battery block 110 that the BMU 34 is disposed on is less than the voltage and current drawn from the battery cells 115 of one or more of the other battery blocks 110. Responsive to the determination, the BMS 150 can send a command signal to increase the voltage and current drawn from the battery cells 115 of the battery block 110 that the BMS 150 is disposed on by the difference. The command signal can be relayed via the voltage trace lines 140 of the sense circuit board 130, the fifth connector element 330, and the conductive trace lines 305 of the circuit board layer 300.

With the receipt of the command signal from the BMS 150, the BMU 340 can perform cell balancing by controlling the electrical impedance components (e.g., the resistors 345 and capacitors 350) in accordance with the command signal. The BMU 340 can receive the command signal specifying an increase in the voltage and the current drawn from the battery cells 115 of the battery block 110 that the BMU 340 is disposed on. In response to receipt of the command signal, the BMU 340 can control the set of electrical impedance components (e.g., the resistors 345 and the capacitors 350) to allow more voltage and current to be released from the battery cells 115 of the battery block 110. In increasing voltage or current, the BMU 340 can perform passive cell balancing by drawing less current through the fixed value resistors 345 with the output of BMU 340 connected to the battery cells 115 identified as outside the range of characteristics for normal operation. The BMU 340 can also perform active cell balancing by switching electrical impedance components between connected and disconnected to vary and decrease current drawn through the electrical impedance components. For electrical impedance components with fixed impedance, the BMU 340 can switch the electrical impedance component (e.g., the resistor 345 and the capacitor 350) coupled with the output of the BMU 340 via the conductive trace lines 305 from connected (e.g., close circuit state) to disconnected (e.g., open circuit state) For electrical impedance components with variable impedance (e.g., the resistor 345 and the capacitor 350), the BMU 340 can determine the impedance based on the amount of increase in the voltage and current specified by the command signal from the BMS 150. The determined impedance value can be less than the previous impedance value. The BMU 340 can set the impedance value of electrical impedance component by sending the signal specifying the impedance value to the control pin of the electrical impedance component.

Conversely, the BMU 340 can receive the command signal from the BMS 150 specifying a decrease in the voltage and the current drawn from the battery cells 115 of the battery block 110 that the BMU 340 is disposed on. In response to receipt of the command signal, the BMU 340 can perform cell balancing by controlling the set of electrical impedance components (e.g., the resistors 345 and the capacitors 350) to absorb or reduce voltage and current released from the battery cells 115 of the battery block 110. In decrease voltage or current, the BMU 340 can perform passive cell balancing by drawing more current through the fixed value resistors 345 with the output of BMU 340 connected to the battery cells 115 identified as outside the range of characteristics for normal operation. The BMU 340 can also perform active cell balancing by switching electrical impedance components between connected and disconnected to vary and increase current drawn through the electrical impedance components. For electrical impedance components with fixed impedance, the BMU 340 can switch the electrical impedance component (e.g., the resistor 345 and the capacitor 350) coupled with the output of the BMU 340 via the conductive trace lines 305 from off to on. For electrical impedance components with variable impedance (e.g., the resistor 345 and the capacitor 350), the BMU 340 can determine the impedance based on the amount of decrease in the voltage and current specified by the command signal from the BMS 150. The determined impedance value can be more than the previous impedance value. The BMU 340 can set the impedance value of electrical impedance component by sending the signal specifying the impedance value to the control pin of the electrical impedance component.

Using at least one signal received from the BMU 340 of the battery module 105, the BMS 150 can also generate at least one notification signal to send to other components of the electrical vehicle. The other components of the electric vehicle can include electronic control units (ECUs), such as an on-board diagnostics unit, a vehicle control unit, a motor control unit, and a powertrain control module, among others. As discussed above, the signal received from the BMU 340 can indicate voltage and current drawn from the battery cells 115, the temperature from heat radiating from the battery blocks 110, the pressured exerted from within the battery blocks 110, and a presence of gaseous substances. The BMS 150 can calculate or determine one or more performance metrics of the battery module 105 or the battery pack using the signal received from the BMU 340. The notification signal can include the one or more performance metric determined by the BMS 150. The BMS 150 can also generate the notification signal based on the comparison of the measured characteristics with the range of characteristics for normal operations of the battery block 110. Responsive to the determination that the measured characteristics are outside the range for normal operations, the BMS 150 can insert, add, or otherwise include an alert indicator into the notification signal. The alert indicator can specify a risk of a fault (e.g., over-voltage, over-current, and high temperature) in the battery module 105 or the battery pack. The alert indicator can also indicate a risk of a fault (e.g., loss of voltage isolation and weakening of structure) from the measured characteristics being outside the range for normal operations. With receipt of the notification signal, the component of the electric vehicle (e.g., ECU) can present the one or more performance metrics and the alert indicator. In addition, responsive to the determination that the measured characteristics are outside range of characteristics for normal operations, the BMS 150 can also disconnect or disengage the battery module 105 or the battery pack from one or more components of the electric vehicle (e.g., high-voltage (HV) components).

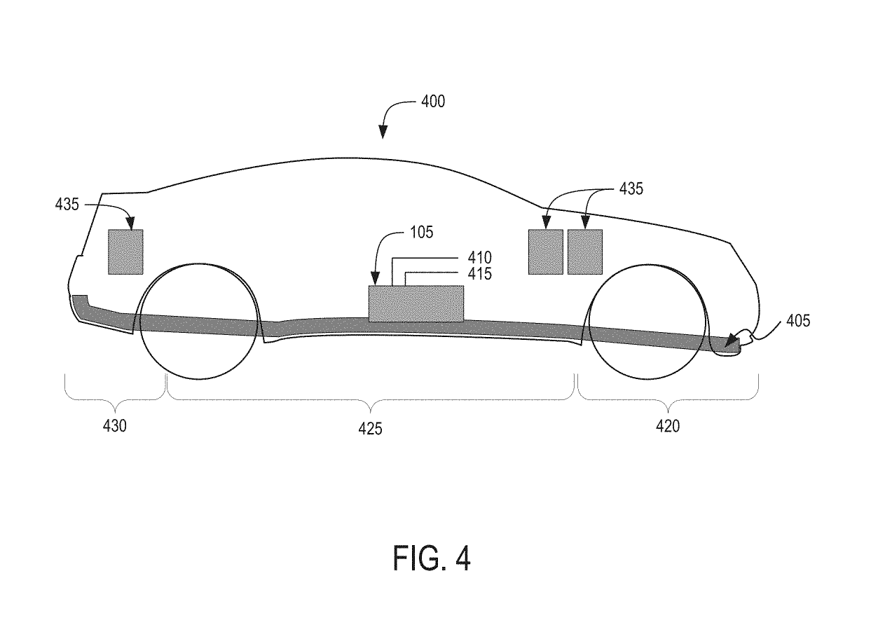

FIG. 4 depicts a cross-section view of an electric vehicle 400 installed with a battery module 105. The electric vehicle 400 can include a chassis 405 (e.g., a frame, internal frame, or support structure). The chassis 405 can support various components of the electric vehicle 400. The chassis 405 can span a front portion 420 (e.g., a hood or bonnet portion), a body portion 425, and a rear portion 430 (e.g., a trunk portion) of the electric vehicle 400. The one or more battery modules 105 can be installed or placed within the electric vehicle 400. The one or more battery modules 105 can be installed on the chassis 405 of the electric vehicle 400 within the front portion 420, the body portion 425 (as depicted in FIG. 4), or the rear portion 430. The BMU 340 can be integrated into the battery module 105. The battery module 105 can provide electrical power to one or more other components 435 by electrically coupling the positive terminals of the battery cells 115 with at least one positive current collector 410 (sometimes referred herein to as a positive busbar) and by electrically coupling the negative terminals of the battery cells 115 with at least one negative current collector 415 (sometimes referred herein to as a negative busbar). The positive current collector 410 can be electrically coupled with the positive terminal of the battery module 105. The negative current collector 415 can be electrically coupled with the negative terminal of the battery module 105. The one or more components 435 can include an electric engine, an entertainment system (e.g., a radio, display screen, and sound system), on-board diagnostics system, and electric control units (ECUs) (e.g., an engine control module, a transmission control module, a brake control module, and a body control module), among others.

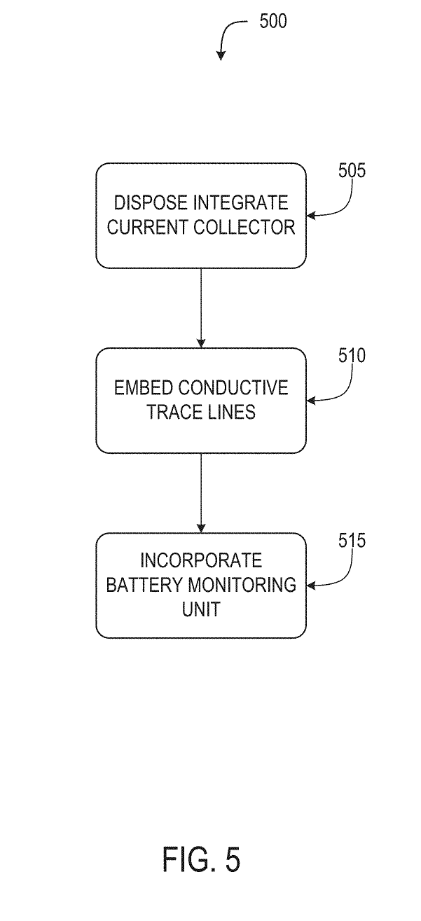

FIG. 5 depicts a flow diagram of a method 500 of providing energy storage with component monitoring capability. The method 500 can be performed or implemented using the components detailed above in conjunction with FIGS. 1-5. The method 500 can include disposing an integrated current collector 135 in a battery block 110 of a battery module 105 (ACT 505). The battery module 105 can be installed or arranged in an electric vehicle 400. The integrated current collector 135 can span on side of the battery block 110 (e.g., top surface 205). The integrated current collector 135 can have a top conductive layer 120, a bottom conductive layer 125, and a circuit board layer 300. Each of the top conductive layer 120, the bottom conductive layer 125, and the circuit board layer 300 can define a set of openings to expose or pass the positive and negative terminals of the battery cells 115 of the battery block 110. The top conductive layer 120 can be electrically coupled with one of the polarity terminals of the battery cells 115 of the battery block 110. The bottom conductive layer 125 can be electrically coupled with the other polarity terminal of the battery cells 115 of the battery block 110. One surface of the top conductive layer 120 can be at least partially flush with one surface of the bottom conductive layer 125. The other surface of the top conductive layer 120 can be at least partially flush with one surface of the circuit board layer 300.

The method 500 can include embedding conductive trace lines 305 (ACT 510). The conductive trace lines 305 can be embedded or integrated into the integrated current collector 135. An electrical conductive material for the conductive trace line 305 can be etched, imprinted, deposited, plated, laminated, or milled onto the circuit board layer 300 of the integrated current collector 135. The conductive trace line 305 can span a portion of one surface of the circuit board layer 300. The conductive trace lines 305 can electrically couple various components of the battery module 105, such as the top conductive layer 120, the bottom conductive layer 125, electrical impedance components (e.g., the resistors 345 and capacitors 350), or the polarity terminals of the individual battery cells 115, or sensors disposed thereon. The ends of the conductive trace line 305 can be in contact with the components of the battery module 105 via wire bonding, ball bonding, compliant bonding, or direct contact, among others.

The method 500 can include incorporating a battery monitoring unit (BMU) 340 (ACT 515). The BMU 340 can be incorporated onto the circuit board layer 300 of the integrated current collector 135. The BMU 340 can include one or more processors, memory, and input/output interfaces. A set of contact leads or insert holes can be etched, imprinted, deposited, plated, laminated, milled, or otherwise defined along a surface of the circuit board layer 300 to connect to the pins of the BMU 340. The contact leads or insert holes can be electrically coupled with the conductive trace lines 305. The inputs and outputs of the BMU 340 can be electrically coupled with various components of the battery module 105 via the conductive trace lines 305. From the conductive trace lines 305 connected to the input, the BMU 340 can obtain signals indicative of various characteristics of the components of the battery module 105. The characteristics can include voltage and current drawn from the battery cells 115, the temperature from heat radiating from the battery blocks 110, the pressured exerted from within the battery blocks 110, and a presence of gaseous substances. Based on the characteristics, the BMU 340 can control the electrical impedance components (e.g., the resistors 345 and capacitors 350) electrically coupled with the conductive trace lines 305 connected to the outputs of the BMU 340. The BMU 340 can switch on or off the electrical impedance components or adjust an impedance of the electrical impedance component.

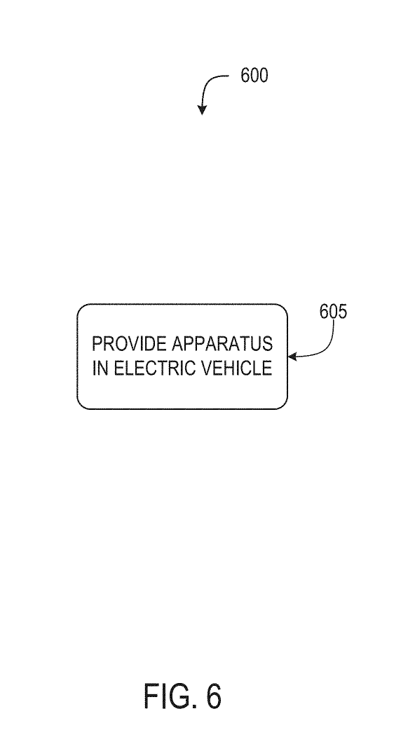

FIG. 6 depicts a flow diagram of a method 600 of providing energy storage with component monitoring capability. The method 600 can be performed or implemented using the components detailed above in conjunction with FIGS. 1-4. The method 600 can include providing an apparatus 100 into an electric vehicle 400 (ACT 605). The apparatus 100 can include a battery block 110 disposed in a battery module 105. The battery block 110 can have a set of battery cells 115 to store and provide electrical energy. An integrated current collector 135 can be arranged in the battery block 110. The integrated current collector 135 can have a top conductive layer 120 and a bottom conductive layer 135. The top conductive layer 120 can be electrically coupled with one of the polarity terminals of the battery cells 115 housed in the battery block 110. The bottom conductive layer 125 can be electrically coupled with the other polarity terminal of the battery cell 115 housed in the battery block 110. The integrated current collector 135 in at least one of the battery blocks 110 of the battery module 105 can also have a circuit board layer 300. The circuit board layer 300 can be arranged along one surface of the top conductive layer 120. A set of electrically conductive trace lines 305 can be embedded into the integrated current collector 135 of the battery block 110, such as along the top surface of the circuit board layer 300. The electrically conductive trace lines 305 can be connected to various components of the battery block 110, such as the top conductive layer 120, the bottom conductive layer 125, individual battery cells 115, and the sensors disposed therein. A battery monitoring unit (BMU) 340 can be incorporated into the integrated current collector 135, such as along the top surface of the circuit board layer 300. Inputs and outputs of the BMU 340 can be electrically coupled with various components of the battery block 110 through the conductive trace lines 305. From the inputs, the BMU 340 can acquire one or more signals indicative of characteristics of the components of the battery block 110, such as voltage and current drawn from the battery cells 115, temperature of the battery block 110, pressure exerted from within the battery block 110, and presence of gaseous substances released from the battery cells 115, among others. Based on the characteristics, the BMU 340 can control the components of the battery block 110 through the conductive trace lines 305 connected to the outputs of the BMU 340. The BMU 340 can control electrical impedance components (e.g., resistors 345 and capacitors 350) to absorb or allow release of voltage and current from the battery cells 115 of the battery block 110.

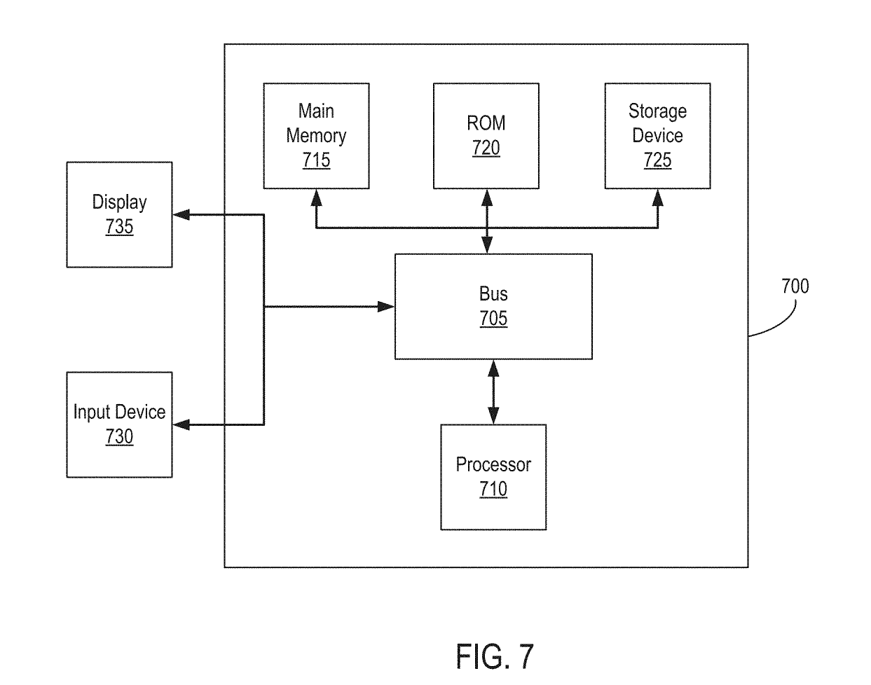

FIG. 7 depicts a block diagram of an example computer system 700. The computer system or computing device 700 can include or be used to implement the BMU 340 and the BMS 150. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the BMS 150 or BMU 340. The main memory 715 can also be used for storing position information, vehicle information, command instructions, vehicle status information, environmental information within or external to the vehicle, road status or road condition information, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the BMS 150 or the BMU 340.

The computing system 700 may be coupled via the bus 705 to a display 735, such as a liquid crystal display, or active matrix display, for displaying information to a user such as a driver of the electric vehicle 400. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 can be coupled with the BMS 150 or the BMU 340 to display various diagnostic data regarding the apparatus 100.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

While operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. Further, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An apparatus to store electrical energy in electrical vehicles to power components therein, comprising:
a battery block disposed in a battery pack of an electric vehicle to power the electric vehicle;
a plurality of battery cells disposed within the battery block to store electrical energy;
an integrated current collector disposed within the battery block to electrically couple the plurality of battery cells in parallel, the integrated current collector having a first conductive layer to connect with first polarity terminals of the plurality of battery cells, a second conductive layer to connect with second polarity terminals of the plurality of battery cells, and a circuit board layer parallel to the first conductive layer and the second conductive layer;
a plurality of electrically conductive trace lines each at least partially embedded in the integrated current collector and formed on the circuit board layer, the plurality of electrically conductive trace lines having a first electrically conductive trace line electrically connected to the first conductive layer and a second electrically conductive trace line electrically connected to the second conductive layer, the first electrically conductive trace line electrically isolated from the second electrically conductive trace line; and
a battery monitoring unit (BMU) incorporated into the integrated current collector on the circuit board layer, the BMU having a first input electrically coupled with the first conductive layer via the first electrically conductive trace line on the circuit board layer and having a second input electrically coupled with the second conductive layer via the second electrically conductive trace line on the circuit board layer, to obtain a signal indicative of a characteristic of the battery block.

2. The apparatus of claim 1, comprising:
a second battery block disposed in the battery pack separate from the first battery block;
a second plurality of battery cells disposed in the second battery block, each electrically isolated from the first battery block;
the plurality of electrically conductive trace lines having a third electrically conductive trace line electrically coupled with one of the first polarity terminals or the second polarity terminals of the second plurality of battery cells via a connector element, the third electrically conductive trace line electrically isolated from the first electrically conductive trace line and the second electrically conductive trace line; and
the BMU having a third input electrically coupled with the one of the first polarity terminals or the second polarity terminals of the second plurality of battery cells via the third electrically conductive trace line to obtain a second signal indicative of a characteristic of the second battery block.

3. The apparatus of claim 1, comprising:
the plurality of electrically conductive trace lines having a third electrically conductive trace line electrically coupled with an output of the BMU;
a sense circuit board disposed on the battery pack having a connector to electrically couple an external device with the output of the BMU via the third electrically conductive trace line; and
the BMU to relay the signal indicative of the characteristic of the battery pack via the third electrically conductive trace line to the external device electrically coupled with the connector of the sense circuit board.

4. The apparatus of claim 1, comprising:
the plurality of electrically conductive trace lines having a third electrically conductive trace line electrically coupled with a third input of the BMU;
a sense circuit board disposed on the battery pack having a connector to electrically couple an external device and the third input of the of the BMU via the third electrically conductive trace line; and
the BMU to receive, from the external device via the third input and the third electrically conductive trace line, a command signal to control at least one of voltage and current of the plurality of battery cells.

5. The apparatus of claim 1, comprising:
a sensor disposed within the battery block to measure the characteristic of the battery block;
the plurality of electrically conductive trace lines having a third electrically conductive trace line electrically coupled with the sensor; and
the BMU having a third input electrically coupled with the sensor via the third electrically conductive trace line to obtain the signal indicative of the characteristic of the battery block.

6. The apparatus of claim 1, comprising:
a plurality of electrical impedance components disposed on the circuit board layer of the integrated current collector, each coupled with at least one of the first conductive layer and the second conductive layer;
the plurality of electrically conductive trace lines having a third electrically conductive trace line electrically coupled with one of the first polarity terminals or the second polarity terminals of a second plurality of battery cells disposed in a second battery block to relay a second signal indicative of a characteristic of the second battery block; and
the BMU having a third input electrically coupled with the one of the first polarity terminals or the second polarity terminals of the second plurality of battery cells via the third electrically conductive trace line to control at least one of voltage and current of the plurality of battery cells disposed in the battery block using the plurality of electrical impedance components according to the characteristic of the second battery block.

7. The apparatus of claim 1, comprising:
a plurality of electrical impedance components spatially distributed on the circuit board layer of the integrated current collector, the plurality of electrical impedance components including a fixed resistor and a fixed capacitor;
the plurality of electrically conductive trace lines having a third electrically conductive trace line to connect the fixed resistor with the BMU and a fourth electrically conductive trace line to connect the fixed capacitor with the BMU; and
the BMU to at least one of: switch the fixed resistor between a connected state and a disconnected state via the third electrically conductive trace line, and switch the fixed capacitor between a connected state and a disconnected state via the fourth electrical conductive trace line, to control at least one of voltage and current of the plurality of the battery cells.

8. The apparatus of claim 1, comprising:
a plurality of electrical impedance components spatially distributed on the circuit board layer of the integrated current collector, the plurality of electrical impedance components including a variable resistor and a variable capacitor;
the plurality of electrically conductive trace lines having a third electrically conductive trace line to connect the variable resistor with the BMU and a fourth electrically conductive trace line to connect the variable capacitor with the BMU; and
the BMU to at least one of: control a resistance of the variable resistor via the third electrically conductive trace line, and control a capacitance of the capacitor state via the fourth electrical conductive trace line, to control at least one of voltage and current of the plurality of the battery cells.

9. The apparatus of claim 1, comprising:
a plurality of electrical impedance components arranged on the circuit board layer of the integrated current collector, the plurality of electrical impedance components having a resistor and a capacitor both within a distance of a location of the BMU disposed on the circuit board layer; and
the plurality of electrically conductive trace lines having a third electrically conductive trace line to connect the resistor with the BMU and a fourth electrically conductive trace line to connect the capacitor with the BMU, an entirety of the third electrically conductive trace line and an entirety of the fourth conductive trace line within the distance of the location of the BMU.

10. The apparatus of claim 1, comprising:
a plurality of electrical impedance components disposed on the circuit board layer of the integrated current collector, the plurality of electrical impedance components including a variable resistor and a variable capacitor, the variable resistor having a first pin to electrically couple with the first conductive layer, a second pin to electrically couple with the second conductive layer in parallel, a third pin electrically coupled with the BMU to control a resistance of the variable resistor, the variable capacitor having a first pin to electrically couple with the first conductive layer, a second pin to electrically couple with the second conductive layer in parallel, and a third pin electrically coupled with the BMU to control a capacitance of the variable capacitor.

11. The apparatus of claim 1, comprising:
a battery monitoring system (BMS) electrically coupled with the BMU to receive the signal indicative of the characteristic of the battery block and to generate a second signal to send to an electrical control unit (ECU) of the electric vehicle based on the characteristic of the battery block.

12. The apparatus of claim 1, comprising:
the integrated current collector having the circuit board layer disposed above the first conductive layer and the second conductive layer and having an insulating layer between the first conductive layer and the second conductive layer to electrically isolate the first conductive layer and the second conductive layer, a first surface of the insulating layer flush with a surface of the first conductive layer, a second surface of the insulating layer flush with a surface the second conductive layer.

13. The apparatus of claim 1, comprising:
the plurality of electrically conductive trace lines having the first electrically conductive trace line connected to the first conductive layer via wire bond and the second electrically conductive trace line connected to the second conductive layer via wire bond.

14. The apparatus of claim 1, comprising:
the first conductive layer of the integrated current collector defining a first plurality of openings including one opening to expose the first polarity terminal and the second polarity terminal of one of the plurality of battery cells;
the second conductive layer of the integrated current collector defining a second plurality of openings including one opening to expose the first polarity terminal and the second polarity terminal of the one of the plurality of battery cells, the second plurality of openings at least partially aligned with the first plurality of openings; and
the circuit board layer of the integrated current collector defining a third plurality of openings including one opening to expose the first polarity terminal and the second polarity terminal of the one of the plurality of battery cells, the third plurality of openings at least partially aligned with the first plurality of openings and the second plurality of openings.

15. The apparatus of claim 1, comprising:
the first conductive layer of the integrated current collector having a thickness ranging between 0.5 mm to 1 mm;
the second conductive layer of the integrated current collector having a thickness ranging between 0.5 mm to 1 mm; and
the circuit board layer of the integrated current collector having a thickness ranging between 0.75 mm to 2 mm.

16. A method, comprising:
providing a battery pack to arrange in an electric vehicle to power the electric vehicle, the battery pack having:
a battery block;
a plurality of battery cells disposed within the battery block to store electrical energy;
an integrated current collector disposed within the battery block to electrically couple the plurality of battery cells in parallel, the integrated current collector having a first conductive layer to connect with first polarity terminals of the plurality of battery cells, a second conductive layer to connect with second polarity terminals of the plurality of battery cells, and a circuit board layer parallel to the first conductive layer and the second conductive layer;
a plurality of electrically conductive trace lines each at least partially embedded in the integrated current collector and formed on the circuit board layer, the plurality of electrically conductive trace lines having a first electrically conductive trace line electrically connected to the first conductive layer and a second electrically conductive trace line electrically connected to the second conductive layer, the first electrically conductive trace line electrically isolated from the second electrically conductive trace line; and
a battery monitoring unit (BMU) incorporated into the integrated current collector on the circuit board layer, the BMU having a first input electrically coupled with the first conductive layer via the first electrically conductive trace line on the circuit board layer and having a second input electrically coupled with the second conductive layer via the second electrically conductive trace line on the circuit board layer, to obtain a signal indicative of a characteristic of the battery block.

17. The method of claim 16, comprising:
providing the battery pack, the battery pack having:
a second battery block disposed in the battery pack separate from the first battery block;
a second plurality of battery cells disposed in the second battery block, each electrically isolated from the first battery block;
the plurality of electrically conductive trace lines having a third electrically conductive trace line electrically coupled with one of the first polarity terminals or the second polarity terminals of the second plurality of battery cells via a connector element, the third electrically conductive trace line electrically isolated from the first electrically conductive trace line and the second electrically conductive trace line; and
the BMU having a third input electrically coupled with the one of the first polarity terminals or the second polarity terminals of the second plurality of battery cells via the third electrically conductive trace line to obtain a second signal indicative of a characteristic of the second battery block.

18. The method of claim 16, comprising:
providing the battery pack, the battery pack having:
a plurality of electrical impedance components disposed on the circuit board layer of the integrated current collector, each coupled with at least one of the first conductive layer and the second conductive layer;
the plurality of electrically conductive trace lines having a third electrically conductive trace line electrically coupled with one of the first polarity terminals or the second polarity terminals of a second plurality of battery cells disposed in a second battery block to relay a second signal indicative of a characteristic of the second battery block; and
the BMU having a third input electrically coupled with the one of the first polarity terminals or the second polarity terminals of the second plurality of battery cells via the third electrically conductive trace line to control at least one of voltage and current of the plurality of battery cells disposed in the battery block using the plurality of electrical impedance components according to the characteristic of the second battery block.

19. An electric vehicle, comprising:
one or more components;
a battery block disposed in a battery pack of to power the one or more components;
a plurality of battery cells disposed within the battery block to store electrical energy;
an integrated current collector disposed within the battery block to electrically couple the plurality of battery cells in parallel, the integrated current collector having a first conductive layer to connect with first polarity terminals of the plurality of battery cells, a second conductive layer to connect with second polarity terminals of the plurality of battery cells, and a circuit board layer parallel to the first conductive layer and the second conductive layer;
a plurality of electrically conductive trace lines each at least partially embedded in the integrated current collector and formed on the circuit board layer, the plurality of electrically conductive trace lines having a first electrically conductive trace line electrically connected to the first conductive layer and a second electrically conductive trace line electrically connected to the second conductive layer, the first electrically conductive trace line electrically isolated from the second electrically conductive trace line; and
a battery monitoring unit (BMU) incorporated into the integrated current collector on the circuit board layer, the BMU having a first input electrically coupled with the first conductive layer via the first electrically conductive trace line on the circuit board layer and having a second input electrically coupled with the second conductive layer via the second electrically conductive trace line on the circuit board layer, to obtain a signal indicative of a characteristic of the battery block.

20. The electric vehicle of claim 19, comprising:
a second battery block disposed in the battery pack separate from the first battery block;
a second plurality of battery cells disposed in the second battery block, each electrically isolated from the first battery block;
the plurality of electrically conductive trace lines having a third electrically conductive trace line electrically coupled with one of the first polarity terminals or the second polarity terminals of the second plurality of battery cells via a connector element, the third electrically conductive trace line electrically isolated from the first electrically conductive trace line and the second electrically conductive trace line; and
the BMU having a third input electrically coupled with the one of the first polarity terminals or the second polarity terminals of the second plurality of battery cells via the third electrically conductive trace line to obtain a second signal indicative of a characteristic of the second battery block.
